(19) United States
(12) Patent Application Publication
(10) Pub. No.: US 2026/0291649 A1
(43) Pub. Date: Sep. 24, 2026

(54) METHOD OF PERFORMING REPETITION TRANSMISSION USING MULTIPLE TRANSMIT ANTENNAS AND RECEPTION METHOD

(71) Applicant: CHINA SATELLITE NETWORK INNOVATION CO.,LTD, Beijing (CN)

(72) Inventors: Lu ZHANG, Beijing (CN); Xue WANG, Beijing (CN); Gaojian WANG, Beijing (CN); Ge MANG, Beijing (CN); Qinglong WANG, Beijing (CN); Qiyuan YAO, Beijing (CN); Yang ZHANG, Beijing (CN); Xuetian ZHU, Beijing (CN)

(21) Appl. No.: 19/650,774

(22) Filed: Apr. 17, 2026

Related U.S. Application Data
(63) Continuation of application No. PCT/CN2025/119474, filed on Sep. 5, 2025.

(30) Foreign Application Priority Data
Mar. 20, 2025 (CN) 202510332567.7

(51) Int. Cl. H04L 1/08

(52) U.S. Cl. CPC H04L 1/08

(57) ABSTRACT

A method of performing repetition transmission using multiple transmit antennas. The method includes: acquiring a code symbol sequence after channel coding and modulation; converting, using an orthogonal space-time block code, the code symbol sequence into a precoding matrix of the orthogonal space-time block code based on repetition transmission; and transmitting the precoding matrix using 2N transmit antennas, where N is a positive integer greater than or equal to 1.

### CROSS-REFERENCE TO RELATED APPLICATIONS

The present application is a continuation under 35 U.S.C. § 111(a) of International Patent Application No. PCT/CN2025/119474, filed on Sep. 5, 2025, which claims priority to Chinese Patent Application No. 202510332567.7, entitled “Method of Performing Repetition Transmission Using Multiple Transmit Antennas and Reception Method”, and filed on Mar. 20, 2025, both of which are incorporated by reference in the present application in their entirety.

### TECHNICAL FIELD

The present application belongs to the technical field of communication networks, in particular to a method of performing repetition transmission using multiple transmit antennas and a reception method.

### BACKGROUND

The standardization process of a 3GPP 5G NTN (Non-Terrestrial Network) involves coverage enhancement for satellite-ground links, including the uplink coverage enhancement discussed in Rel-18 and the downlink coverage enhancement discussed in Rel-19. However, with the existing technical means, the link budget still fails to reach a relatively desirable level for the transmission of certain channels or reference signals. The current approaches to achieving coverage enhancement in NTNs by signal processing means mainly involve the reuse of the methods employed for coverage enhancement in terrestrial networks, which, for example, may include: repetition transmission, increasing the proportion of error correction bits in the channel coding output, spreading one PUSCH (Physical Uplink Shared Channel) transport block across multiple available time slots for transmission to obtain higher channel coding gain, jointly utilizing the DMRSs (Demodulation Reference Signals) of multiple time slots during repetition transmission to enhance the accuracy of channel estimation, etc.

As is evident, the existing signal processing technologies aimed at achieving coverage enhancement in NTNs all achieve the improvement in error performance at the cost of reducing the information transmission rate, in other words, a reduction in throughput/capacity is exchanged for an improvement in coverage capability.

Regarding how to achieve more significant coverage enhancement by means of the signal processing technologies at the cost of the same throughput reduction, no effective solution has been proposed yet.

### SUMMARY

A method of performing repetition transmission using multiple transmit antennas, applied to a transmitter, including: acquiring a code symbol sequence (c₁, c₂, . . . , c_{K}) after channel coding and modulation, wherein K represents a number of code symbols in the code symbol sequence, and K is a positive integer; converting, using an orthogonal space-time block code, the code symbol sequence (c₁, c₂, . . . , c_{K}) into a precoding matrix of the orthogonal space-time block code based on repetition transmission; and transmitting the precoding matrix using 2N transmit antennas, wherein N is a positive integer greater than or equal to 1.

A data reception method, applied to a receiver, wherein when a number of repetition transmissions is 2, the method includes: receiving a precoding matrix of an orthogonal space-time block code based on repetition transmission; obtaining, in a space-time-domain signal processing scenario, for each target code symbol, corresponding received signals at two consecutive symbol moments, and calculating, for the received signals at the two consecutive symbol moments, two decision variables for the same target code symbol based on a symbol-level maximum likelihood decision algorithm for the orthogonal space-time block code; or, obtaining, in a space-frequency-domain signal processing scenario, for each target code symbol, corresponding received signals on two consecutive subcarriers, and calculating, for the received signals on the two consecutive subcarriers, two decision variables for the same target code symbol based on a symbol-level maximum likelihood decision algorithm for the orthogonal space-time block code; and additively combining the two decision variables for the same target code symbol to obtain a target decision variable corresponding to the target code symbol.

A data reception method, applied to a receiver, wherein when a number of repetition transmissions is 2q and q is a positive integer greater than or equal to 2, the method includes receiving a precoding matrix of an orthogonal space-time block code based on repetition transmission; obtaining, in a space-time-domain signal processing scenario, for each target code symbol, corresponding received signals at q groups of symbol moments each of which contains two consecutive symbol moments, and calculating, for two received signals obtained at each of the q groups of symbol moments, two decision variables for the same target code symbol based on a symbol-level maximum likelihood decision algorithm for the orthogonal space-time block code, and additively combining the two decision variables to obtain q initial combined decision variables corresponding to the same target code symbol; or, obtaining, in a space-frequency-domain signal processing scenario, for each target code symbol, corresponding received signals on q groups of subcarriers each of which contains two consecutive subcarriers, and calculating, for two received signals obtained on each of the q groups of subcarriers, two decision variables for the same target code symbol based on a symbol-level maximum likelihood decision algorithm for the orthogonal space-time block code, and additively combining the two decision variables to obtain q initial combined decision variables corresponding to the same target code symbol; and additively combining the q initial combined decision variables corresponding to the same target code symbol to obtain a target decision variable corresponding to the target code symbol.

A method of performing repetition transmission using multiple transmit antennas, applied to a transmitter, including: acquiring a code symbol sequence (c₁, c₂, . . . , c_{K}) after channel coding and modulation, wherein K represents a number of code symbols in the code symbol sequence, and K is a positive integer; converting, when K is an even number, the code symbol sequence into a code symbol sequence (s₁, s₂, . . . , s_{L}), wherein L=K, and sᵢ=cᵢ (i=1, . . . , L); or, additionally appending, when K is an odd number, a symbol with a value of zero to an end of the code symbol sequence to obtain a code symbol sequence (s₁, s₂, . . . , s_{L}), wherein L=K+1, sᵢ=cᵢ (i=1, . . . , L−1), and s_{L}=0; converting, using an orthogonal space-time block code, every 2N symbols in the code symbol sequence (s₁, s₂, . . . , s_{L}) into a precoding matrix of the orthogonal space-time block code; and repeatedly transmitting the precoding matrix using 2N transmit antennas in matrix-wise granularity, and additionally transmitting at least one bit of control information, wherein the at least one bit of control information is used to indicate whether zero-padding has been performed at the end of a currently transmitted code symbol sequence.

A data reception method, applied to a receiver, wherein when a number of repetition transmissions is p, wherein p is a positive integer greater than or equal to 2, the method includes: receiving a precoding matrix of an orthogonal space-time block code based on repetition transmission, wherein the precoding matrix of an orthogonal space-time block code is obtained by converting every 2N symbols in a code symbol sequence (s₁, s₂, . . . , s_{L}) using the orthogonal space-time block code; obtaining, in a space-time-domain signal processing scenario, for every two target code symbols, corresponding received signals at p groups of symbol moments each of which contains two consecutive symbol moments, and calculating, for two received signals obtained at each of the p groups of symbol moments, two initial decision variables each of which respectively corresponds to one of the two target code symbols based on a symbol-level maximum likelihood decision algorithm for the orthogonal space-time block code, and obtaining, based on the corresponding p groups of received signals obtained at the p groups of symbol moments, p initial decision variables for each of the two target code symbols; or, obtaining, in a space-frequency-domain signal processing scenario, for every two target code symbols, corresponding received signals on p groups of subcarriers each of which contains two consecutive subcarriers, and calculating, for two received signals obtained on each of the p groups of subcarriers, two initial decision variables each of which respectively corresponds to one of the two target code symbols based on a symbol-level maximum likelihood decision algorithm for the orthogonal space-time block code, and obtaining, based on the corresponding p groups of received signals obtained on the p groups of subcarriers, p initial decision variables for each of the two target code symbols; additively combining, for each of the two target code symbols, the p initial decision variables to obtain a corresponding target decision variable; and after completing decision-making and obtaining a decision result according to the target decision variable for each symbol in the code symbol sequence (s₁, s₂, . . . , s_{L}), deciding, according to a reception result of at least one bit of control information, whether to remove a last symbol from the decision result for the code symbol sequence (s₁, s₂, . . . , s_{L}).

A transmitter, including: an acquisition module for acquiring a code symbol sequence (c₁, c₂, . . . , c_{K}) after channel coding and modulation, wherein K represents a number of code symbols in the code symbol sequence; a conversion module for converting, using an orthogonal space-time block code, the code symbol sequence (c₁, c₂, . . . , c_{K}) into a precoding matrix of the orthogonal space-time block code based on repetition transmission; and a transmitting module for transmitting the precoding matrix using 2N transmit antennas, wherein N is a positive integer greater than or equal to 1.

A receiver, including: a first receiving module for receiving, when a number of repetition transmissions is 2, a precoding matrix of an orthogonal space-time block code based on repetition transmission; a first calculation module for obtaining, in a space-time-domain signal processing scenario, for each target code symbol, corresponding received signals at two consecutive symbol moments, and calculating, for the received signals at the two consecutive symbol moments, two decision variables for the same target code symbol based on a symbol-level maximum likelihood decision algorithm for the orthogonal space-time block code; or a second calculation module for obtaining, in a space-frequency-domain signal processing scenario, for each target code symbol, corresponding received signals on two consecutive subcarriers, and calculating, for the received signals on the two consecutive subcarriers, two decision variables for the same target code symbol based on a symbol-level maximum likelihood decision algorithm for the orthogonal space-time block code; and a first combination module for additively combining the two decision variables for the same target code symbol to obtain a target decision variable corresponding to the target code symbol.

A receiver, including: a second receiving module for receiving, when a number of repetition transmissions is 2q and q is a positive integer greater than or equal to 2, a precoding matrix of an orthogonal space-time block code based on repetition transmission; a third calculation module for obtaining, in a space-time-domain signal processing scenario, for each target code symbol, corresponding received signals at q groups of symbol moments each of which contains two consecutive symbol moments, and calculating, for the received signals obtained at the two consecutive symbol moments contained in each of the q groups of symbol moments, two decision variables for the same target code symbol based on a symbol-level maximum likelihood decision algorithm for the orthogonal space-time block code, and additively combining the two decision variables to obtain q initial combined decision variables corresponding to the same target code symbol; or, a fourth calculation module for obtaining, in a space-frequency-domain signal processing scenario, for each target code symbol, corresponding received signals on q groups of subcarriers each of which contains two consecutive subcarriers, and calculating, for the received signals obtained on the two consecutive subcarriers contained in each of the q groups of subcarriers, two decision variables for the same target code symbol based on a symbol-level maximum likelihood decision algorithm for the orthogonal space-time block code, and additively combining the two decision variables to obtain q initial combined decision variables corresponding to the same target code symbol; and a second combination module for additively combining the q initial combined decision variables corresponding to the same target code symbol to obtain a target decision variable corresponding to the target code symbol.

A computer-readable storage medium having stored thereon a computer program/instruction which, when executed by a processor, implements steps of the method as described above.

### BRIEF DESCRIPTION OF DRAWINGS

In order to more clearly illustrate the technical solutions in the embodiments of the present disclosure or in the prior art, the drawings required for describing the embodiments or the prior art will be briefly introduced below. Obviously, the figures described below only illustrate some embodiments of the present disclosure. For a person of ordinary skill in the art, other figures may also be obtained based on these figures without paying creative efforts.

FIG. 1 is a method flowchart of an embodiment of the method of performing repetition transmission using multiple transmit antennas as provided by the present application;

FIG. 2 is a method flowchart of an embodiment of the data reception method for the method of performing repetition transmission using multiple transmit antennas as provided by the present application;

FIG. 3 is a method flowchart of another embodiment of the data reception method for the method of performing repetition transmission using multiple transmit antennas as provided by the present application;

FIG. 4 is a block diagram of a hardware structure of a transmitter/receiver as provided by the present application;

FIG. 5 is a schematic structural diagram of an embodiment of an apparatus for performing repetition transmission using multiple transmit antennas on the transmitter side as provided by the present application;

FIG. 6 is a schematic structural diagram of an embodiment of an apparatus for performing repetition transmission using multiple transmit antennas on the receiver side as provided by the present application; and

FIG. 7 is a schematic structural diagram of another embodiment of an apparatus for performing repetition transmission using multiple transmit antennas on the receiver side as provided by the present application.

### DESCRIPTION OF EMBODIMENTS

In order to enable a person skilled in the art to better understand the technical solutions in the present disclosure, the technical solutions in the embodiments of the present disclosure will be described clearly and completely with reference to the figures in the embodiments of the present disclosure, and obviously, the embodiments described herein are only part of, rather than all of the embodiments of the present disclosure. Based on the embodiments of the present disclosure, all other embodiments obtained by a person of ordinary skill in the art without paying any creative effort shall fall within the scope of protection of the present application.

Although the fading characteristic on satellite-ground wireless links is Rician fading dominated by Line of Sight (LOS) paths, making it difficult to achieve significant spatial multiplexing gain and/or spatial diversity gain with multi-antenna technologies as in terrestrial networks, the link budget on satellite-ground wireless links is relatively tight, especially for the uplink which is even more strained due to the limited maximum transmit power of the terminal. Therefore, it is necessary to consider how to efficiently utilize multi-antenna technology to improve the system coverage capability in Rician fading channels. Given that the transmit diversity gain achievable in Rician fading channels is limited, the use of multi-antenna transmit diversity technology alone cannot achieve the desired effect. Therefore, it is considered to combine common signal processing methods capable of improving the coverage capability (e.g., repetition transmission, and spreading one PUSCH transport block across multiple available time slots (TBoMS) for transmission) with multi-antenna transmit diversity technology to further effectively improve the system coverage capability through reasonable design. In an example, the present application considers combining orthogonal space-time block codes with repetition transmission.

For orthogonal space-time block codes to be applied to space-time-domain signal processing, the channel's time-domain variation is required to be quasi-static rather than at a symbol level. Similarly, for orthogonal space-time block codes to be applied to space-frequency-domain signal processing, the channel's frequency-domain variation is required to be frequency-flat rather than at a subcarrier level. In an NTN constructed by high-speed low earth orbit satellites, although there is high relative mobility between a network-side communication node and a terminal, after practical frequency offset compensation (including spectrum pre-compensation at the UE side, or joint compensation at both the network side and the UE side), Doppler frequency shifts of considerable magnitude will also be compensated to an almost negligible level. Therefore, in a practical commercial NTN system, it is not necessary to deal with time-domain channel variation at the symbol level during space-time-domain signal processing, but only with quasi-static time-domain channel variation. Meanwhile, as mentioned above, the satellite-ground wireless communication links are dominated by LOS paths, so there are few multipath components, resulting in a small delay spread. This means that the coherence bandwidth is large. Therefore, in an NTN system, a flat frequency-domain channel variation is faced during space-frequency-domain signal processing. In summary, orthogonal space-time block codes are applicable in NTN systems.

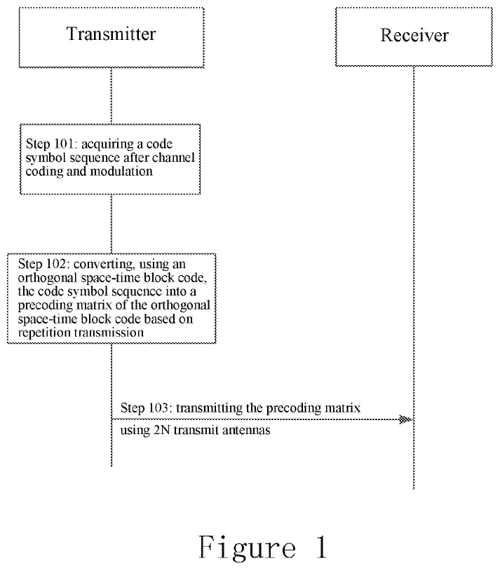

FIG. 1 is a method flowchart of an embodiment of the method of performing repetition transmission using multiple transmit antennas as provided by the present application. Although the present application provides the method operation steps or apparatus structures shown in the embodiments or figures described below, more or fewer operation steps or module units may be included in the method or apparatus based on conventional or non-inventive effort. For steps or structures among which no necessary causal relationship exists logically, their execution order or the module structure of the apparatus is not limited to the order or structures described in the embodiments or shown in the figures of the present application. When the described methods or module structures are applied to actual apparatus or terminal products, they may be executed sequentially or in parallel according to the method or module connections shown in the embodiments or figures (e.g., in a parallel processor, multi-threaded processing environment, or even a distributed processing environment).

In an example, as shown in FIG. 1, the aforementioned method of performing repetition transmission using multiple antennas, applied to a transmitter side, may include the following steps:
Step 101: acquiring a code symbol sequence (c₁, c₂, . . . , c_{K}) after channel coding and modulation, wherein K represents a number of code symbols in the code symbol sequence, and K is a positive integer;
wherein the transmitter may be a terminal, and may also be a base station. That is, the method may be applied to an uplink with a terminal as the transmitter, and may also be applied to a downlink with a base station as the transmitter. Correspondingly, when the transmitter is a terminal, the receiver is a base station, and when the transmitter is a base station, the receiver is a terminal.

In Step 101, the transmitter may acquire an information bit sequence to be transmitted, and then perform processing such as channel coding and modulation on the information bit sequence to be transmitted, thereby obtaining the code symbol sequence (c₁, c₂, . . . , c_{K}).
Step 102: converting, using an orthogonal space-time block code, the code symbol sequence (c₁, c₂, . . . , c_{K}) into a precoding matrix of the orthogonal space-time block code based on repetition transmission;
wherein the orthogonal space-time block code may be an Alamouti code, which is a full-rate (i.e., rate-1) orthogonal space-time block code when the transmitter is configured with 2Tx, wherein 2Tx refers to two radio frequency channels used for transmission (i.e., two transmit antennas). In an example, the Alamouti code may be represented as: if “x₁ and x₂” are used to represent the input symbols to the multi-antenna signal precoding matrix corresponding to the 2Tx Alamouti code, then the multi-antenna signal precoding matrix corresponding to the 2Tx Alamouti code may be represented as:

$$[ \begin{matrix}{x}_{1} & {x}_{2} \\ - {x}_{2}^{*} & {x}_{1}^{*}\end{matrix} ]$$

If the Alamouti code is applied to a space-time-domain signal processing scenario, for any given signal carrier/subcarrier, in the aforementioned multi-antenna signal precoding matrix, the first column represents transmit symbols of a first transmit antenna, the second column represents transmit symbols of a second transmit antenna, the first row represents transmit symbols at a t^{th} symbol moment, and the second row represents transmit symbols at a (t+1)^{th} symbol moment. If the Alamouti code is applied to a space-frequency-domain signal processing scenario, for any given OFDM symbol moment, in the aforementioned multi-antenna signal precoding matrix, the first column represents transmit symbols of a first transmit antenna, the second column represents transmit symbols of a second transmit antenna, the first row represents transmit symbols on an m^{th} subcarrier, and the second row represents transmit symbols on a (m+1)^{th} subcarrier.

In an example, by using an orthogonal space-time block code, the code symbol sequence (c₁, c₂, . . . , c_{K}) is converted into a precoding matrix of the orthogonal space-time block code based on repetition transmission. The core design idea of a method of performing repetition transmission in code symbol-wise granularity is as follows: In a multi-antenna signal precoding matrix corresponding to the Alamouti code, both x₁ and x₂ are set equal to the same code symbol to be transmitted. The way of implementation may include:
1) When the value of N is 1 and the number of repetition transmissions is 2, for each code symbol cᵢ in the code symbol sequence, the converted precoding matrix of the orthogonal space-time block code based on repetition transmission may be represented as:

$$[ \begin{matrix}{c}_{i} & {c}_{i} \\ - {c}_{i}^{*} & {c}_{i}^{*}\end{matrix} ]$$

wherein the first column represents transmit symbols of a first transmit antenna, and the second column represents transmit symbols of a second transmit antenna, and in a space-time-domain signal processing scenario, the first row represents transmit symbols at a t^{th} symbol moment, and the second row represents transmit symbols at a (t+1)^{th} symbol moment; or, in a space-frequency-domain signal processing scenario, the first row represents transmit symbols on an m^{th} subcarrier, and the second row represents transmit symbols on a (m+1)^{th} subcarrier.
2) When the value of N is 1 and the number of repetition transmissions is 2q, for each code symbol cᵢ in the code symbol sequence, the converted precoding matrices of the orthogonal space-time block code based on repetition transmission may be represented as:

$$[ \begin{matrix}{c}_{i} & {c}_{i} \\ - {c}_{i}^{*} & {c}_{i}^{*}\end{matrix} ]$$

$$…$$

$$[ \begin{matrix}{c}_{i} & {c}_{i} \\ - {c}_{i}^{*} & {c}_{i}^{*}\end{matrix} ]$$

wherein q is a positive integer greater than or equal to 2, the first column represents transmit symbols of a first transmit antenna, and the second column represents transmit symbols of a second transmit antenna, and in a space-time-domain signal processing scenario, the first row represents transmit symbols at a t^{th} symbol moment, the second row represents transmit symbols at a (t+1)^{th} symbol moment, the second-from-last row represents transmit symbols at a (t+2q−2)^{th} symbol moment, and the last row represents transmit symbols at a (t+2q−1)^{th} symbol moment; or, in a space-frequency-domain signal processing scenario, the first row represents transmit symbols on an m^{th} subcarrier, the second row represents transmit symbols on a (m+1)^{th} subcarrier, the second-from-last row represents transmit symbols on a (m+2q−2)^{th} subcarrier, and the last row represents transmit symbols on a (m+2q−1)^{th} subcarrier.
3) When the value of N is 2 and the number of repetition transmissions is 2, for every two code symbols cᵢ and cᵢ₊₁ in the code symbol sequence, the converted precoding matrix of the orthogonal space-time block code based on repetition transmission may be represented as:

$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$

wherein the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-time-domain signal processing scenario, the first row represents transmit symbols at a t^{th} symbol moment, the second row represents transmit symbols at a (t+1)^{th} symbol moment, the third row represents transmit symbols at a (t+2)^{th} symbol moment, and the fourth row represents transmit symbols at a (t+3)^{th} symbol moment; or, in a space-frequency-domain signal processing scenario, the first row represents transmit symbols on an m^{th} subcarrier, the second row represents transmit symbols on a (m+1)^{th} subcarrier, the third row represents transmit symbols on a (m+2)^{th} subcarrier, and the fourth row represents transmit symbols on a (m+3)^{th} subcarrier.
4) When the value of N is 2 and the number of repetition transmissions is 2q, for every two code symbols cᵢ and cᵢ₊₁ in the code symbol sequence, the converted precoding matrices of the orthogonal space-time block code based on repetition transmission may be represented as:

$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$

$$…$$

$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$

wherein q is a positive integer greater than or equal to 2, the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-time-domain signal processing scenario, the first row represents transmit symbols at a t^{th} symbol moment, the second row represents transmit symbols at a (t+1)^{th} symbol moment, the third row represents transmit symbols at a (t+2)^{th} symbol moment, the fourth row represents transmit symbols at a (t+3)^{th} symbol moment, the fourth-from-last row represents transmit symbols at a (t+4q−4)^{th} symbol moment, the third-from-last row represents transmit symbols at a (t+4q−3)^{th} symbol moment, the second-from-last row represents transmit symbols at a (t+4q−2)^{th} symbol moment, and the last row represents transmit symbols at a (t+4q−1)^{th} symbol moment; or, in a space-frequency-domain signal processing scenario, the first row represents transmit symbols on an m^{th} subcarrier, the second row represents transmit symbols on a (m+1)^{th} subcarrier, the third row represents transmit symbols on a (m+2)^{th} subcarrier, the fourth row represents transmit symbols on a (m+3)^{th} subcarrier, the fourth-from-last row represents transmit symbols on a (m+4q−4)^{th} subcarrier, the third-from-last row represents transmit symbols on a (m+4q−3)^{th} subcarrier, the second-from-last row represents transmit symbols on a (m+4q−2)^{th} subcarrier, and the last row represents transmit symbols on a (m+4q−1)^{th} subcarrier.

In the following, for different configurations of the number of transmit antennas, the number of repetition transmissions, and the number of code symbols, several embodiments of the precoding matrix of the orthogonal space-time block code based on repetition transmission are provided:
1) When the value of N is 1, the number of repetition transmissions is 2, and the number of code symbols is 3, the converted precoding matrices of the orthogonal space-time block code based on repetition transmission may be represented as:

$$[ \begin{matrix}{c}_{1} & {c}_{1} \\ - {c}_{1}^{*} & {c}_{1}^{*}\end{matrix} ]$$

$$[ \begin{matrix}{c}_{2} & {c}_{2} \\ - {c}_{2}^{*} & {c}_{2}^{*}\end{matrix} ]$$

$$[ \begin{matrix}{c}_{3} & {c}_{3} \\ - {c}_{3}^{*} & {c}_{3}^{*}\end{matrix} ]$$

wherein the first column represents transmit symbols of a first transmit antenna, the second column represents transmit symbols of a second transmit antenna, the first row represents transmit symbols at a first symbol moment, the second row represents transmit symbols at a second symbol moment, the third row represents transmit symbols at a third symbol moment, the fourth row represents transmit symbols at a fourth symbol moment, the fifth row represents transmit symbols at a fifth symbol moment, the sixth row represents transmit symbols at a sixth symbol moment, c₁ represents a first code symbol, c₂ represents a second code symbol, and c₃ represents a third code symbol.
2) When the value of N is 1, the number of repetition transmissions is 4, and the number of code symbols is 2, the converted precoding matrices of the orthogonal space-time block code based on repetition transmission may be represented as:

$$[ \begin{matrix}{c}_{1} & {c}_{1} \\ - {c}_{1}^{*} & {c}_{1}^{*}\end{matrix} ]$$

$$[ \begin{matrix}{c}_{1} & {c}_{1} \\ - {c}_{1}^{*} & {c}_{1}^{*}\end{matrix} ]$$

$$[ \begin{matrix}{c}_{2} & {c}_{2} \\ - {c}_{2}^{*} & {c}_{2}^{*}\end{matrix} ]$$

$$[ \begin{matrix}{c}_{2} & {c}_{2} \\ - {c}_{2}^{*} & {c}_{2}^{*}\end{matrix} ]$$

wherein the first column represents transmit symbols of a first transmit antenna, the second column represents transmit symbols of a second transmit antenna, the first row represents transmit symbols at a first symbol moment, the second row represents transmit symbols at a second symbol moment, the third row represents transmit symbols at a third symbol moment, the fourth row represents transmit symbols at a fourth symbol moment, the fifth row represents transmit symbols at a fifth symbol moment, the sixth row represents transmit symbols at a sixth symbol moment, the seventh row represents transmit symbols at a seventh symbol moment, the eighth row represents transmit symbols at an eighth symbol moment, c₁ represents a first code symbol, and c₂ represents a second code symbol.
3) When the value of N is 2, the number of repetition transmissions is 2, and the number of code symbols is 2, the converted precoding matrix of the orthogonal space-time block code based on repetition transmission may be represented as:

$$[ \begin{matrix}{c}_{1} & 0 & {c}_{1} & 0 \\ - {c}_{1}^{*} & 0 & {c}_{1}^{*} & 0 \\ 0 & {c}_{2} & 0 & {c}_{2} \\ 0 & - {c}_{2}^{*} & 0 & {c}_{2}^{*}\end{matrix} ]$$

wherein the first column represents transmit symbols of a first transmit antenna, the second column represents transmit symbols of a second transmit antenna, the third column represents transmit symbols of a third transmit antenna, the fourth column represents transmit symbols of a fourth transmit antenna, the first row represents transmit symbols at a first symbol moment, the second row represents transmit symbols at a second symbol moment, the third row represents transmit symbols at a third symbol moment, the fourth row represents transmit symbols at a fourth symbol moment, c₁ represents a first code symbol, and c₂ represents a second code symbol.
Step 103: transmitting the precoding matrix using 2N transmit antennas, wherein N is a positive integer greater than or equal to 1.

For a receiver, it may obtain decision variables with relatively low processing complexity through an orthogonal precoding structure of the Alamouti code itself.

In an example, also provided in this embodiment is a data reception method based on a method of performing repetition transmission using multiple transmit antennas as described above, which is applied to a receiver side. Note: the descriptions in the present disclosure are all given by taking a situation where a 1Rx (i.e., a single receiving radio frequency channel, or a single receive antenna) is used by a receiver for processing as an example. In practical applications, the receiver may also be configured with multiple “radio frequency channels for receiving (or multiple receive antennas)” to achieve additional receive diversity gain.

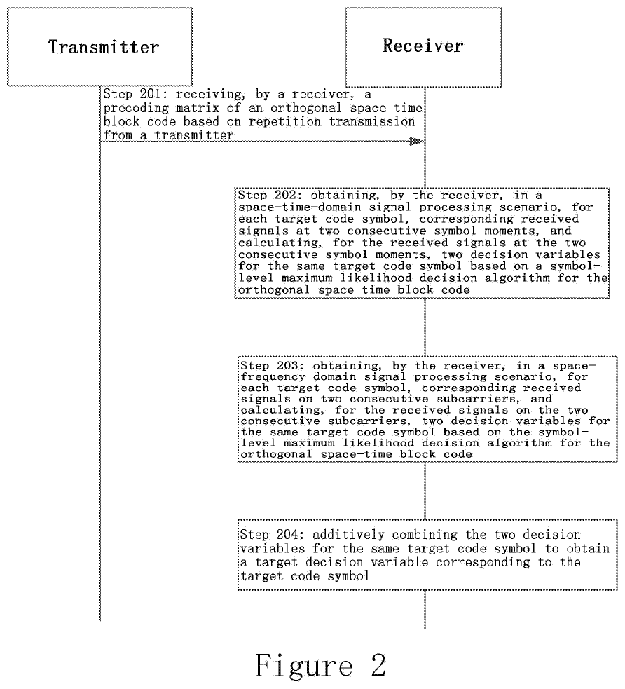

When the number of repetition transmissions is 2, as shown in FIG. 2, the method may include:
Step 201: receiving, by a receiver, a precoding matrix of an orthogonal space-time block code based on repetition transmission from a transmitter;
Step 202: obtaining, by the receiver, in a space-time-domain signal processing scenario, for each target code symbol, corresponding received signals at two consecutive symbol moments, and calculating, for the received signals at the two consecutive symbol moments, two decision variables for the same target code symbol based on a symbol-level maximum likelihood decision algorithm for the orthogonal space-time block code; or,
Step 203: obtaining, by the receiver, in a space-frequency-domain signal processing scenario, for each target code symbol, corresponding received signals on two consecutive subcarriers, and calculating, for the received signals on the two consecutive subcarriers, two decision variables for the same target code symbol based on the symbol-level maximum likelihood decision algorithm for the orthogonal space-time block code; and
Step 204: additively combining the two decision variables for the same target code symbol to obtain a target decision variable corresponding to the target code symbol.

Considering that a space-time-domain signal is repeatedly transmitted 2q times (q≥1) in the time domain, for a symbol cᵢ at the receiver side, a symbol-level maximum likelihood decision algorithm based on the Alamouti code is performed once for every two received signals to obtain two decision variables for the cᵢ; then, the two decision variables for the same symbol cᵢ are simply additively combined to obtain a combined decision variable for the symbol cᵢ; and finally, by simply additively combining the q combined decision variables again, a final decision variable is obtained.

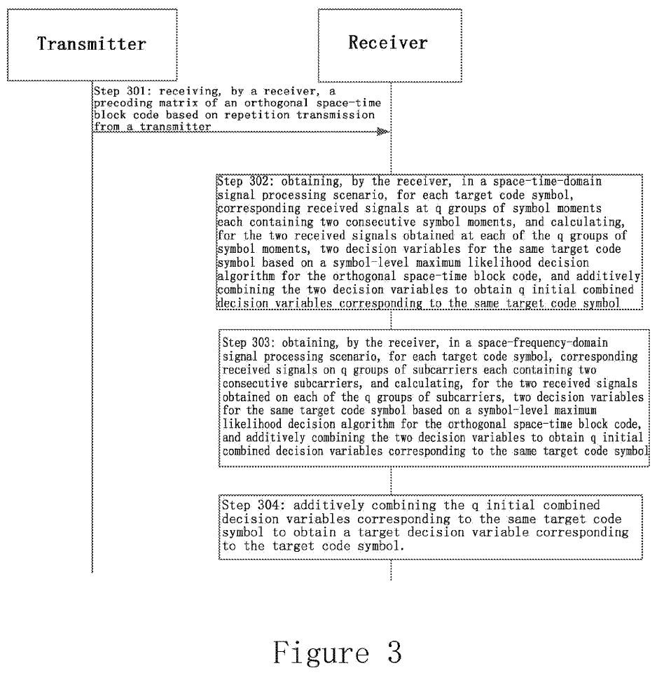

On this basis, also provided in this embodiment is a data reception method based on the method of performing repetition transmission using multiple transmit antennas as described above, which is applied to a receiver side. When the number of repetition transmissions is 2q, wherein q is a positive integer greater than or equal to 2, as shown in FIG. 3, the method may include:
Step 301: receiving, by a receiver, a precoding matrix of an orthogonal space-time block code based on repetition transmission from a transmitter;
Step 302: obtaining, by the receiver, in a space-time-domain signal processing scenario, for each target code symbol, corresponding received signals at q groups of symbol moments each of which contains two consecutive symbol moments, and calculating, for two received signals obtained at each of the q groups of symbol moments, two decision variables for the same target code symbol based on a symbol-level maximum likelihood decision algorithm for the orthogonal space-time block code, and additively combining the two decision variables to obtain q initial combined decision variables corresponding to the same target code symbol; or
Step 303: obtaining, by the receiver, in a space-frequency-domain signal processing scenario, for each target code symbol, corresponding received signals on q groups of subcarriers each of which contains two consecutive subcarriers, and calculating, for two received signals obtained on each of the q groups of subcarriers, two decision variables for the same target code symbol based on a symbol-level maximum likelihood decision algorithm for the orthogonal space-time block code, and additively combining the two decision variables to obtain q initial combined decision variables corresponding to the same target code symbol; and
Step 304: additively combining the q initial combined decision variables corresponding to the same target code symbol to obtain a target decision variable corresponding to the target code symbol.

In an example, in the space-time-domain signal processing scenario, the received signals at two consecutive symbol moments of a t^{th} symbol moment and a (t+1)^{th} symbol moment in a time domain may be represented as:

$${r}^{( t )} = {c}_{i} {h}_{1} + {c}_{i} {h}_{2} + {n}^{( t )}$$

$${r}^{( t + 1 )} = ( - {c}_{i}^{*} ) {h}_{1} + {c}_{i}^{*} {h}_{2} + {n}^{( t + 1 )}$$

wherein r^{(t)} represents a received signal in the time domain at the t^{th} symbol moment, r^{(t+1)} represents a received signal in the time domain at the (t+1)^{th} symbol moment, n^{(t)} and n^{(t+1)} represent additive white Gaussian noise sample values at the t^{th} and (t+1)^{th} symbol moments, respectively, h₁ represents an instantaneous channel coefficient from a first transmit antenna to a single receive antenna in the space-time domain, h₂ represents an instantaneous channel coefficient from a second transmit antenna to a single receive antenna in the space-time domain, and cᵢ represents a target code symbol. As instantaneous channel coefficients of a wireless fading channel in the space-time domain, which wireless fading channel varies quasi-statically in the time domain, the values of h₁ and h₂ change from frame to frame.

In the space-frequency-domain signal processing scenario, the received signals on two consecutive subcarriers of an m^{th} subcarrier and a (m+1)^{th} subcarrier in the frequency domain may be represented as:

$${y}^{( m )} = {c}_{i} {g}_{1} + {c}_{i} {g}_{2} + {z}^{( m )}$$

$${y}^{( m + 1 )} = ( - {c}_{i}^{*} ) {g}_{1} + {c}_{i}^{*} {g}_{2} + {z}^{( m + 1 )}$$

wherein y^{(m)} represents a received signal in the frequency domain on the m^{th} subcarrier, y^{(m+1)} represents a received signal in the frequency domain on the (m+1)^{th} subcarrier, z^{(m)} and z^{(m+1)} represent additive white Gaussian noise sample values on the m^{th} and (m+1)^{th} subcarriers, respectively, g₁ represents an instantaneous channel coefficient from a first transmit antenna to a single receive antenna in the space-frequency domain, g₂ represents an instantaneous channel coefficient from a second transmit antenna to a single receive antenna in the space-frequency domain, and cᵢ represents a target code symbol. As instantaneous channel coefficients of a wireless fading channel in the space-frequency domain, which wireless fading channel varies in a flat manner in the frequency domain, the values of g₁ and g₂ change from subband to subband, or from RBG (Resource Block Group) to RBG.

Correspondingly, in the space-time-domain signal processing scenario, for the received signals at the two consecutive symbol moments of the t^{th} symbol moment and the (t+1)^{th} symbol moment in the time domain, the two decision variables may be calculated based on the symbol-level maximum likelihood decision algorithm for the orthogonal space-time block code according to the following formulas:

$${Δ}_{1} = {f}_{1} ( {r}^{( t )} , {r}^{( t + 1 )} , {h}_{1} , {h}_{2} ) = {( {h}_{1} )}^{*} {r}^{( t )} + {{h}_{2} ( {r}^{( t + 1 )} )}^{*} = ( {\vert {h}_{1} \vert}^{2} + {\vert {h}_{2} \vert}^{2} ) {c}_{i} + ( {( {h}_{1} )}^{*} {n}^{( t )} + {{h}_{2} ( {n}^{( t + 1 )} )}^{*} )$$

$${Δ}_{2} = {f}_{2} ( {r}^{( t )} , {r}^{( t + 1 )} , {h}_{1} , {h}_{2} ) = {( {h}_{2} )}^{*} {r}^{( t )} - {{h}_{1} ( {r}^{( t + 1 )} )}^{*} = ( {\vert {h}_{1} \vert}^{2} + {\vert {h}_{2} \vert}^{2} ) {c}_{i} + ( {( {h}_{2} )}^{*} {n}^{( t )} - {{h}_{1} ( {n}^{( t + 1 )} )}^{*} )$$

wherein Δ₁ represents a first decision variable, Δ₂ represents a second decision variable, ƒ₁( [symbol] ) and ƒ₂( [symbol] ) represent maximum likelihood decision functions, and * represents a conjugate operation.

In the space-frequency-domain signal processing scenario, for the received signals on the two consecutive subcarriers of the m^{th} subcarrier and the (m+1)^{th} subcarrier in the frequency domain, the two decision variables may be calculated based on the symbol-level maximum likelihood decision algorithm for the orthogonal space-time block code according to the following formulas:

$${Δ}_{1} = {f}_{1} ( {y}^{( m )} , {y}^{( m + 1 )} , {g}_{1} , {g}_{2} ) = {( {g}_{1} )}^{*} {y}^{( m )} + {{g}_{2} ( {y}^{( m + 1 )} )}^{*} = ( {\vert {g}_{1} \vert}^{2} + {\vert {g}_{2} \vert}^{2} ) {c}_{i} + ( {( {g}_{1} )}^{*} {z}^{( m )} + {{g}_{2} ( {z}^{( m + 1 )} )}^{*} )$$

$${Δ}_{2} = {f}_{2} ( {y}^{( m )} , {y}^{( m + 1 )} , {g}_{1} , {g}_{2} ) = {( {g}_{2} )}^{*} {y}^{( m )} - {{g}_{1} ( {y}^{( m + 1 )} )}^{*} = ( {\vert {g}_{1} \vert}^{2} + {\vert {g}_{2} \vert}^{2} ) {c}_{i} + ( {( {g}_{2} )}^{*} {z}^{( m )} - {{g}_{1} ( {z}^{( m + 1 )} )}^{*} )$$

wherein Δ₁ represents a first decision variable, Δ₂ represents a second decision variable, and ƒ₁( [symbol] ) and ƒ₂( [symbol] ) represent maximum likelihood decision functions.

According to the derivation results of the above formulas, it can be seen that in the space-time-domain signal processing scenario, the transmit diversity gain can be obtained from |₁|²+|h₂|²; or, in the space-frequency-domain signal processing scenario, the transmit diversity gain can be obtained from |g₁|²+|g₂|².

Next, taking the space-time-domain signal processing scenario as an example, the amount of transmit diversity gain that can be achieved is analyzed as follows: For a commercial device, whether it is a network-side device or a terminal-side device, the correlation in terms of radio frequency processing between the two radio frequency channels for transmission in a 2Tx transmitter is generally weak (they are almost uncorrelated); if the two wireless propagation paths from the first Tx and the second Tx of the 2Tx transmitter to the single Rx are also mutually independent (that is, the h₁ and h₂ are also mutually independent), then the full transmit diversity gain can be achieved (that is, the order of the obtained transmit diversity gain is 2). In terrestrial networks, the wireless propagation paths are mostly NLOS (Non-Line-of-Sight) paths, and the h₁ and h₂ are generally Rayleigh fading coefficients that are mutually independent or approximately mutually independent. Therefore, in most cases, full or nearly full transmit diversity gain can be achieved. In NTNs, the fading characteristic of the wireless propagation paths is Rician fading dominated by Line-of-Sight (LOS) paths, and the h₁ and h₂ are generally not mutually independent but have a strong correlation therebetween. Consequently, generally only limited transmit diversity gain can be obtained.

For satellite communication systems, compared to the existing “1Tx repetition transmission”, which is the mainstream uplink coverage enhancement means, the repetition transmission method based on the Alamouti code proposed in the present application can more efficiently improve the coverage capability. The solutions proposed in the present disclosure reasonably and effectively combine orthogonal space-time block codes with repetition transmission. Accordingly, in satellite communication systems, whether on a terminal side or on a satellite-based base station side, whenever there is a need to improve the coverage capability, repetition transmission based on orthogonal space-time block codes can be performed using multiple antennas in the “space-time domain” or “space-frequency domain”, thereby obtaining both the “limited transmit diversity gain that can be achieved in a Rician fading channel” and the “diversity gain in another dimension brought about by repetition transmission” with relatively low processing complexity. In satellite communication systems, when the proportion of an LOS path component in a satellite-ground Rician fading channel is less than 100%, the solutions proposed in the present disclosure can achieve a better bit error rate performance than the “1Tx repetition transmission” scheme while maintaining the same total transmit power and incurring the same throughput reduction cost. In practical commercial satellite communication systems, in many scenarios, the proportion of the LOS path component in a satellite-ground Rician fading channel is less than 100%.

The aforementioned method is described in the following in combination with a specific embodiment. However, it is worth noting that this specific embodiment is only for better illustration of the present application but does not constitute an improper limitation on the present application.

In this embodiment, for satellite communication systems (including low earth orbit satellite communication systems), a terminal is used as the transmitter, and 2Tx is used to perform the transmission of an orthogonal space-time block code based on repetition transmission on an uplink. Taking space-time-domain signal processing as an example, the specific design of the terminal in terms of transmit signal processing is introduced below.

For each code symbol cᵢ (i=1, 2, . . . ) output after channel coding and modulation, taking a number of repetition transmissions of 2 as an example: For each i (i∈{1, 2, . . . }), the way of performing repetition transmission on cᵢ using 2Tx is as follows: using an Alamouti code, and setting both x₁ and x₂ to be equal to the cᵢ in the multi-antenna signal precoding matrix corresponding to the Alamouti code as described in Step 102 of FIG. 1. In an example, taking the transmission of 3 code symbols c₁, c₂ and c₃ by a 2Tx terminal as an example, the corresponding Alamouti code precoding matrices based on repetition transmission may be represented as:

$$\begin{matrix}{1}^{st} symbol moment \to \\ {2}^{nd} symbol moment \to \end{matrix} [ \begin{matrix}{c}_{1} & {c}_{1} \\ - {c}_{1}^{*} & {c}_{1}^{*}\end{matrix} ]$$

$$\begin{matrix}{3}^{rd} symbol moment \to \\ {4}^{th} symbol moment \to \end{matrix} [ \begin{matrix}{c}_{2} & {c}_{2} \\ - {c}_{2}^{*} & {c}_{2}^{*}\end{matrix} ]$$

$$\begin{matrix}{5}^{th} symbol moment \to \\ {6}^{th} symbol moment \to \end{matrix} \begin{matrix}[ \begin{matrix}{c}_{3} & {c}_{3} \\ - {c}_{3}^{*} & {c}_{3}^{*}\end{matrix} ] \\ \begin{matrix}↑ & ↑\end{matrix} \\ \begin{matrix}{1}^{st} Tx & {2}^{nd} Tx\end{matrix}\end{matrix}$$

It can be seen that the above transmission mode completes repetition transmission of cᵢ (i=1, 2, . . . ) in the space-time dimension. In the time domain, only one symbol is transmitted at two consecutive symbol moments, that is, two repetition transmissions are performed for each symbol. Meanwhile, from the perspective of the space domain, each symbol is transmitted by each one of the two Txs, which provides the possibility to achieve the transmit diversity gain in the space domain. Of course, at this point, the transmit power on each Tx is halved as compared to a terminal configured with only a 1Tx.

Further, on a satellite-based base station side serving as the receiver, the decision variables for the cᵢ can be obtained with relatively low processing complexity by means of the orthogonal precoding structure of the Alamouti code itself.

It is evident that the coverage enhancement scheme presented in this embodiment, as proposed in the present disclosure, can simultaneously obtain both the “limited transmit diversity gain that can be achieved in a Rician fading channel” and the “diversity gain in another dimension brought about by repetition transmission” with relatively low processing complexity. Regarding the aforementioned space-time-domain signal transmission processing, the diversity gain in another dimension brought about by repetition transmission is the time diversity gain.

Taking the transmission of 3 code symbols c₁, c₂ and c₃ by a 2Tx terminal with a number of repetition transmissions of 4 as an example, the corresponding Alamouti code precoding matrices based on repetition transmission may be represented as:

$$\begin{matrix}{1}^{st} symbol moment \to \\ {2}^{nd} symbol moment \to \end{matrix} [ \begin{matrix}{c}_{1} & {c}_{1} \\ - {c}_{1}^{*} & {c}_{1}^{*}\end{matrix} ]$$

$$\begin{matrix}{3}^{rd} symbol moment \to \\ {4}^{th} symbol moment \to \end{matrix} [ \begin{matrix}{c}_{1} & {c}_{1} \\ - {c}_{1}^{*} & {c}_{1}^{*}\end{matrix} ]$$

$$\begin{matrix}{5}^{th} symbol moment \to \\ {6}^{th} symbol moment \to \end{matrix} [ \begin{matrix}{c}_{2} & {c}_{2} \\ - {c}_{2}^{*} & {c}_{2}^{*}\end{matrix} ]$$

$$\begin{matrix}{7}^{th} symbol moment \to \\ {8}^{th} symbol moment \to \end{matrix} [ \begin{matrix}{c}_{2} & {c}_{2} \\ - {c}_{2}^{*} & {c}_{2}^{*}\end{matrix} ]$$

$$\begin{matrix}{9}^{th} symbol moment \to \\ {10}^{th} symbol moment \to \end{matrix} [ \begin{matrix}{c}_{3} & {c}_{3} \\ - {c}_{3}^{*} & {c}_{3}^{*}\end{matrix} ]$$

$$\begin{matrix}{11}^{th} symbol moment \to \\ {12}^{th} symbol moment \to \end{matrix} \begin{matrix}[ \begin{matrix}{c}_{3} & {c}_{3} \\ - {c}_{3}^{*} & {c}_{3}^{*}\end{matrix} ] \\ \begin{matrix}↑ & ↑\end{matrix} \\ \begin{matrix}{1}^{st} Tx & {2}^{nd} Tx\end{matrix}\end{matrix}$$

In an implementation, the above description is made taking a situation of two transmit antennas as an example, that is, taking 2Tx as an example. In the following, still taking a terminal as the transmitter and taking space-time-domain signal processing as an example, an embodiment in which the coverage enhancement scheme proposed by the present application is employed by a 4Tx terminal is described. In an example, taking the transmission of 2 code symbols c₁ and c₂ by a 4Tx terminal with a number of repetition transmissions of 2 as an example, the corresponding Alamouti code precoding matrices based on repetition transmission may be represented as:

$$\begin{matrix}{1}^{st} symbol moment \to \\ {2}^{nd} symbol moment \to \\ {3}^{rd} symbol moment \to \\ {4}^{th} symbol moment \to \end{matrix} \begin{matrix}[ \begin{matrix}{c}_{1} & 0 & {c}_{1} & 0 \\ - {c}_{1}^{*} & 0 & {c}_{1}^{*} & 0 \\ 0 & {c}_{2} & 0 & {c}_{2} \\ 0 & - {c}_{2}^{*} & 0 & {c}_{2}^{*}\end{matrix} ] \\ \begin{matrix}↑ & ↑ & ↑ & ↑\end{matrix} \\ \begin{matrix}Tx 1 & Tx 2 & Tx 3 & Tx 4\end{matrix}\end{matrix}$$

In the present application, it is considered that repetition transmission may also be performed on an original Alamouti code matrix in matrix-wise granularity. If repetition transmission is performed in matrix-wise granularity, the number of symbols contained in the symbol sequence serving as an input to the Alamouti code encoding processing needs to be an even number. If the actual number of symbols is an odd number, it is necessary to append a “zero” to the end of the symbol sequence, then the genuine last symbol and this appended “zero” symbol together form a fundamental Alamouti code matrix, and after that repetition transmission is performed in matrix-wise granularity. In order to identify whether zero-padding has been performed, in this embodiment, it is considered that the transmitter may additionally transmit at least one bit to indicate to the receiver whether zero-padding has been performed at the end of the current symbol sequence. For the receiver, it may determine, based on this indication bit, whether an operation of removing the redundant “zero” that has been appended needs to be performed. This additionally increases the control overhead of the system. Furthermore, when performing p repetition transmissions in matrix-wise granularity, each symbol can only be demodulated after the receiver has received 2p signal transmissions. In contrast, for the aforementioned method of performing repetition transmission based on an orthogonal space-time block code at a granularity of code symbols, when performing p repetition transmissions, each symbol can be demodulated as soon as the receiver receives p signal transmissions.

Based on the aforementioned method of performing repetition transmission in matrix-wise granularity, the present application provides another method of performing repetition transmission using multiple transmit antennas, which includes the following steps:
S1: acquiring, by a transmitter, a code symbol sequence (c₁, c₂, . . . , c_{K}) after channel coding and modulation, wherein K represents a number of code symbols in the code symbol sequence;
S2: converting, when K is an even number, the code symbol sequence into a code symbol sequence (s₁, s₂, . . . , s_{L}), wherein L=K, and sᵢ=cᵢ (i=1, . . . , L); or, additionally appending, when K is an odd number, a symbol with a value of zero to an end of the code symbol sequence to obtain a code symbol sequence (s₁, s₂, . . . , s_{L}), wherein L=K+1, sᵢ=cᵢ (i=1, . . . , L−1), and s_{L}=0;
S3: converting, using an orthogonal space-time block code, every 2N symbols in the code symbol sequence (s₁, s₂, . . . , s_{L}) into a precoding matrix of the orthogonal space-time block code; and
S4: repeatedly transmitting the precoding matrix to a receiver using 2N transmit antennas in matrix-wise granularity, and additionally transmitting at least one bit of control information, wherein the at least one bit of control information is used to indicate to the receiver whether zero-padding has been performed at the end of a currently transmitted code symbol sequence.

In an example, the repeated transmitting of the precoding matrix to a receiver using 2N transmit antennas in matrix-wise granularity may include:
1) When the value of N is 1, and the number of repetition transmissions is p, and p is a positive integer greater than or equal to 2, for every two code symbols sᵢ and sᵢ₊₁ in the code symbol sequence (s₁, s₂, . . . , s_{L}), the matrices transmitted when performing the repetition transmissions in matrix-wise granularity may be represented as:

$$[ \begin{matrix}{s}_{i} & {s}_{i + 1} \\ - {s}_{i}^{*} & {s}_{i + 1}^{*}\end{matrix} ]$$

$$…$$

$$[ \begin{matrix}{s}_{i} & {s}_{i + 1} \\ - {s}_{i + 1}^{*} & {s}_{i}^{*}\end{matrix} ]$$

wherein the first column represents transmit symbols of a first transmit antenna, and the second column represents transmit symbols of a second transmit antenna, and in a space-time-domain signal processing scenario, the first row represents transmit symbols at a t^{th} symbol moment, the second row represents transmit symbols at a (t+1)^{th} symbol moment, the second-from-last row represents transmit symbols at a (t+2p−2)^{th} symbol moment, and the last row represents transmit symbols at a (t+2p−1)^{th} symbol moment; or, in a space-frequency-domain signal processing scenario, the first row represents transmit symbols on an m^{th} subcarrier, the second row represents transmit symbols on a (m+1)^{th} subcarrier, the second-from-last row represents transmit symbols on a (m+2p−2)^{th} subcarrier, and the last row represents transmit symbols on a (m+2p−1)^{th} subcarrier.
2) When the value of N is 2, the number of repetition transmissions is p, and p is a positive integer greater than or equal to 2, for every four code symbols sᵢ, sᵢ₊₁, sᵢ₊₂ and sᵢ₊₃ in the code symbol sequence (s₁, s₂, . . . , s_{L}), the matrices transmitted when performing the repetition transmissions in matrix-wise granularity may be represented as:

$$[ \begin{matrix}{s}_{i} & 0 & {s}_{i + 1} & 0 \\ - {s}_{i + 1}^{*} & 0 & {s}_{i}^{*} & 0 \\ 0 & {s}_{i + 2} & 0 & {s}_{i + 3} \\ 0 & - {s}_{i + 3}^{*} & 0 & {s}_{i + 2}^{*}\end{matrix} ]$$

$$…$$

$$[ \begin{matrix}{s}_{i} & 0 & {s}_{i + 1} & 0 \\ - {s}_{i + 1}^{*} & 0 & {s}_{i}^{*} & 0 \\ 0 & {s}_{i + 2} & 0 & {s}_{i + 3} \\ 0 & - {s}_{i + 3}^{*} & 0 & {s}_{i + 2}^{*}\end{matrix} ]$$

wherein the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-time-domain signal processing scenario, the first row represents transmit symbols at a t^{th} symbol moment, the second row represents transmit symbols at a (t+1)^{th} symbol moment, the third row represents transmit symbols at a (t+2)^{th} symbol moment, the fourth row represents transmit symbols at a (t+3)^{th} symbol moment, the fourth-from-last row represents transmit symbols at a (t+4p−4)^{th} symbol moment, the third-from-last row represents transmit symbols at a (t+4p−3)^{th} symbol moment, the second-from-last row represents transmit symbols at a (t+4p−2)^{th} symbol moment, and the last row represents transmit symbols at a (t+4p−1)^{th} symbol moment; or, in a space-frequency-domain signal processing scenario, the first row represents transmit symbols on an m^{th} subcarrier, the second row represents transmit symbols on a (m+1)^{th} subcarrier, the third row represents transmit symbols on a (m+2)^{th} subcarrier, the fourth row represents transmit symbols on a (m+3)^{th} subcarrier, the fourth-from-last row represents transmit symbols on a (m+4p−4)^{th} subcarrier, the third-from-last row represents transmit symbols on a (m+4p−3)^{th} subcarrier, the second-from-last row represents transmit symbols on a (m+4p−2)^{th} subcarrier, and the last row represents transmit symbols on a (m+4p−1)^{th} subcarrier.

For a receiver, it performs data reception. When the number of repetition transmissions is p and p is a positive integer greater than or equal to 2, the method may include the following steps:
S1: receiving, by a receiver, a precoding matrix of an orthogonal space-time block code based on repetition transmission from a transmitter, wherein the precoding matrix of an orthogonal space-time block code is obtained by the transmitter through conversion of every 2N symbols in a code symbol sequence (s₁, s₂, . . . , s_{L}) using the orthogonal space-time block code;
S2: obtaining, by the receiver, in a space-time-domain signal processing scenario, for every two target code symbols, corresponding received signals at p groups of symbol moments each of which contains two consecutive symbol moments, and calculating, for two received signals obtained at each of the p groups of symbol moments, two initial decision variables each of which respectively corresponds to one of the two target code symbols based on a symbol-level maximum likelihood decision algorithm for the orthogonal space-time block code, and obtaining, based on the corresponding p groups of received signals obtained at the p groups of symbol moments, p initial decision variables for each of the two target code symbols; or
S3: obtaining, by the receiver, in a space-frequency-domain signal processing scenario, for every two target code symbols, corresponding received signals on p groups of subcarriers each of which contains two consecutive subcarriers, and calculating, for two received signals obtained on each of the p groups of subcarriers, two initial decision variables each of which respectively corresponds to one of the two target code symbols based on a symbol-level maximum likelihood decision algorithm for the orthogonal space-time block code, and obtaining, based on the corresponding p groups of received signals obtained on the p groups of subcarriers, p initial decision variables for each of the two target code symbols;
S4: additively combining, for each of the two target code symbols, the p initial decision variables to obtain a corresponding target decision variable; and
S5: after completing decision-making and obtaining a decision result according to the target decision variable for each symbol in the code symbol sequence (s₁, s₂, . . . , s_{L}), deciding, according to a reception result of at least one bit of control information, whether to remove a last symbol from the decision result for the code symbol sequence (s₁, s₂, . . . , s_{L}).

That is, in the above embodiment, repetition transmission is performed on an original Alamouti code matrix in the granularity of matrices. In the case where the actual number of symbols is an odd number, the zero-padding processing is performed at the end of the symbol sequence, so that the genuine last symbol and this appended “zero” symbol together form a fundamental Alamouti code matrix, and after that repetition transmission is performed in matrix-wise granularity. In order to enable the receiver side to effectively identify whether zero-padding has been performed, the transmitter additionally transmits at least one bit of control information for the identification, thereby effectively achieving the repetition transmission of the original Alamouti code matrix in matrix-wise granularity.

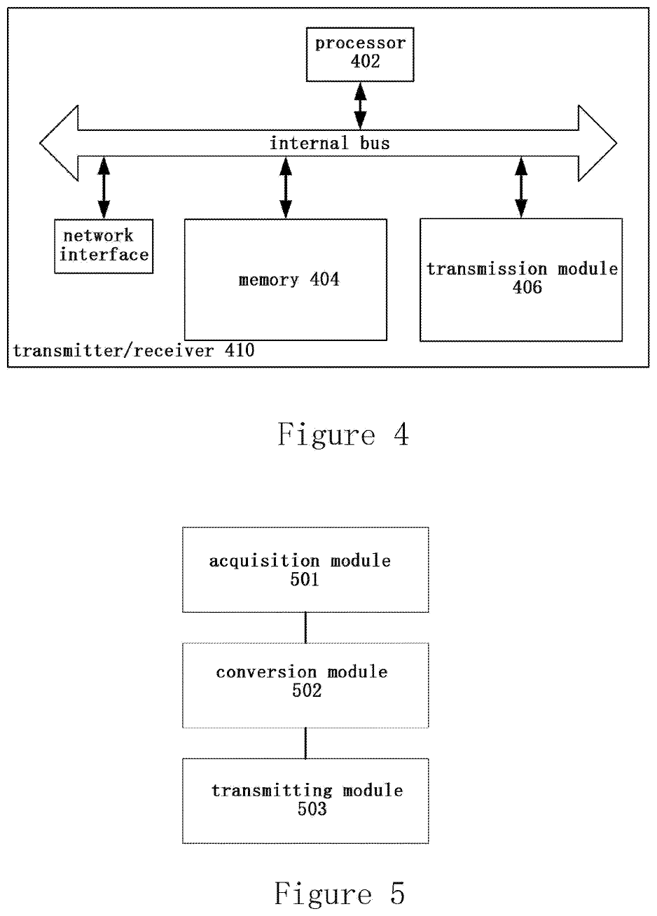

The method embodiments provided in the aforementioned embodiments of the present disclosure may be performed in non-terrestrial networks. Taking the operation on a transmitter/receiver as an example, FIG. 4 is a block diagram of a hardware structure of a transmitter/receiver as provided by the present application. As shown in FIG. 4, the transmitter/receiver 410 may include one or more (only one is shown in the figure) processors 402 (the processor 402 may include, but is not limited to processing means such as a microprocessor (MCU) or a programmable logic device (FPGA)), a memory 404 for data storage, and a transmission module 406 for communication functions. A person of ordinary skill in the art can appreciate that the structure shown in FIG. 4 is merely illustrative and does not impose any limitations on the structure of the electronic device. For example, the transmitter/receiver 410 may also include more or fewer components than those shown in FIG. 4, or have a different configuration from that shown in FIG. 4.

The memory 404 may be used to store software programs and modules of application software, such as the program instructions/modules corresponding to the method of performing repetition transmission using multiple transmit antennas in the embodiments of the present disclosure. By running the software programs and modules stored in the memory 404, the processor 402 executes various functional applications and data processing, that is, implementing the method of performing repetition transmission using multiple transmit antennas of the application program. The memory 404 may include a high-speed random-access memory, and may also include a non-volatile memory, such as one or more magnetic storage devices, flash memories, or other non-volatile solid-state memories. In some embodiments, the memory 404 may further include a memory remotely disposed with respect to the processor 402, and such remote memories may be connected to the non-terrestrial network terminal 410 via a network. Examples of the above-mentioned network include, but are not limited to the Internet, an enterprise intranet, a local area network, a mobile communication network, and a combination thereof.

The transmission module 406 is used to receive or transmit data via a network. Specific examples of the above-mentioned network may include a wireless network provided by a communication provider of the transmitter/receiver 410. In one instance, the transmission module 406 includes a Network Interface Controller (NIC), which may be connected to other network devices through a base station and thus communicate with the Internet. In one example, the transmission module 406 may be a Radio Frequency (RF) module, which is used to communicate with the Internet in a wireless manner.

At the software level, for a transmitter, there is provided an apparatus for performing repetition transmission using multiple transmit antennas, which, as shown in FIG. 5, may include:
an acquisition module 501 for acquiring a code symbol sequence (c₁, c₂, . . . , c_{K}) after channel coding and modulation, wherein K represents a number of code symbols in the code symbol sequence, and K is a positive integer;
a conversion module 502 for converting, using an orthogonal space-time block code, the code symbol sequence (c₁, c₂, . . . , c_{K}) into a precoding matrix of the orthogonal space-time block code based on repetition transmission; and
a transmitting module 503 for transmitting the precoding matrix using 2N transmit antennas, wherein N is a positive integer greater than or equal to 1.

In an embodiment, when the value of N is 1 and the number of repetition transmissions is 2, the conversion module 502 may specifically represent, for each code symbol cᵢ in the code symbol sequence, the converted precoding matrix of the orthogonal space-time block code based on repetition transmission as:

$$[ \begin{matrix}{c}_{i} & {c}_{i} \\ - {c}_{i}^{*} & {c}_{i}^{*}\end{matrix} ]$$

wherein the first column represents transmit symbols of a first transmit antenna, and the second column represents transmit symbols of a second transmit antenna, and in a space-time-domain signal processing scenario, the first row represents transmit symbols at a t^{th} symbol moment, and the second row represents transmit symbols at a (t+1)^{th} symbol moment; or, in a space-frequency-domain signal processing scenario, the first row represents transmit symbols on an m^{th} subcarrier, and the second row represents transmit symbols on an (m+1)^{th} subcarrier.

In an embodiment, when the value of N is 1 and the number of repetition transmissions is 2q, the conversion module 502 may specifically represent, for each code symbol cᵢ in the code symbol sequence, the converted precoding matrices of the orthogonal space-time block code based on repetition transmission as:

$$[ \begin{matrix}{c}_{i} & {c}_{i} \\ - {c}_{i}^{*} & {c}_{i}^{*}\end{matrix} ]$$

$$…$$

$$[ \begin{matrix}{c}_{i} & {c}_{i} \\ - {c}_{i}^{*} & {c}_{i}^{*}\end{matrix} ]$$

wherein q is a positive integer greater than or equal to 2, the first column represents transmit symbols of a first transmit antenna, and the second column represents transmit symbols of a second transmit antenna, and in a space-time-domain signal processing scenario, the first row represents transmit symbols at a t^{th} symbol moment, the second row represents transmit symbols at a (t+1)^{th} symbol moment, the second-from-last row represents transmit symbols at a (t+2q−2)^{th} symbol moment, and the last row represents transmit symbols at a (t+2q−1)^{th} symbol moment; or, in a space-frequency-domain signal processing scenario, the first row represents transmit symbols on an m^{th} subcarrier, the second row represents transmit symbols on a (m+1)^{th} subcarrier, the second-from-last row represents transmit symbols on a (m+2q−2)^{th} subcarrier, and the last row represents transmit symbols on a (m+2q−1)^{th} subcarrier.

In an embodiment, when the value of N is 2 and the number of repetition transmissions is 2, the conversion module 502 may specifically represent, for every two code symbols cᵢ and cᵢ₊₁ in the code symbol sequence, the converted precoding matrix of the orthogonal space-time block code based on repetition transmission as:

$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$

wherein the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-time-domain signal processing scenario, the first row represents transmit symbols at a t^{th} symbol moment, the second row represents transmit symbols at a (t+1)^{th} symbol moment, the third row represents transmit symbols at a (t+2)^{th} symbol moment, and the fourth row represents transmit symbols at a (t+3)^{th} symbol moment; or, in a space-frequency-domain signal processing scenario, the first row represents transmit symbols on an m^{th} subcarrier, the second row represents transmit symbols on a (m+1)^{th} subcarrier, the third row represents transmit symbols on a (M+2)^{th} subcarrier, and the fourth row represents transmit symbols on a (m+3)^{th} subcarrier.

In an embodiment, when the value of N is 2 and the number of repetition transmissions is 2q, the conversion module 502 may specifically represent, for every two code symbols cᵢ and cᵢ₊₁ in the code symbol sequence, the converted precoding matrices of the orthogonal space-time block code based on repetition transmission as:

$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$

$$…$$

$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$

wherein q is a positive integer greater than or equal to 2, the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-time-domain signal processing scenario, the first row represents transmit symbols at a t^{th} symbol moment, the second row represents transmit symbols at a (t+1)^{th} symbol moment, the third row represents transmit symbols at a (t+2)^{th} symbol moment, the fourth row represents transmit symbols at a (t+3)^{th} symbol moment, the fourth-from-last row represents transmit symbols at a (t+4q−4)^{th} symbol moment, the third-from-last row represents transmit symbols at a (t+4q−3)^{th} symbol moment, the second-from-last row represents transmit symbols at a (t+4q−2)^{th} symbol moment, and the last row represents transmit symbols at a (t+4q−1)^{th} symbol moment; or, in a space-frequency-domain signal processing scenario, the first row represents transmit symbols on an m^{th} subcarrier, the second row represents transmit symbols on a (m+1)^{th} subcarrier, the third row represents transmit symbols on a (m+2)^{th} subcarrier, the fourth row represents transmit symbols on a (m+3)^{th} subcarrier, the fourth-from-last row represents transmit symbols on a (m+4q−4)^{th} subcarrier, the third-from-last row represents transmit symbols on a (m+4q−3)^{th} subcarrier, the second-from-last row represents transmit symbols on a (m+4q−2)^{th} subcarrier, and the last row represents transmit symbols on a (m+4q−1)^{th} subcarrier.

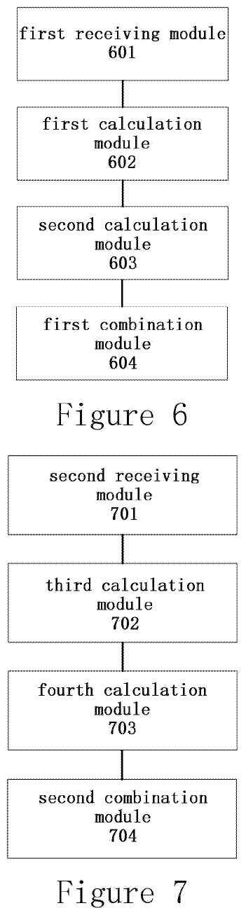

At the software level, for a receiver, there is provided an apparatus for performing repetition transmission using multiple transmit antennas, which, as shown in FIG. 6, may include:
a first receiving module 601 for receiving, when a number of repetition transmissions is 2, a precoding matrix of an orthogonal space-time block code based on repetition transmission from a transmitter;
a first calculation module 602 communicating with the first receiving module 601 for obtaining, in a space-time-domain signal processing scenario, for each target code symbol, corresponding received signals at two consecutive symbol moments, and calculating, for the received signals at the two consecutive symbol moments, two decision variables for the same target code symbol based on a symbol-level maximum likelihood decision algorithm for the orthogonal space-time block code; or a second calculation module 603 communicating with the first receiving module 601 for obtaining, in a space-frequency-domain signal processing scenario, for each target code symbol, corresponding received signals on two consecutive subcarriers, and calculating, for the received signals on the two consecutive subcarriers, two decision variables for the same target code symbol based on a symbol-level maximum likelihood decision algorithm for the orthogonal space-time block code; and
a first combination module 604 communicating with the first calculation module 602 and the second calculation module 603 for additively combining the two decision variables for the same target code symbol to obtain a target decision variable corresponding to the target code symbol.

At the software level, for a receiver, there is further provided an apparatus for performing repetition transmission using multiple transmit antennas, which, as shown in FIG. 7, may include:
a second receiving module 701 for receiving, when a number of repetition transmissions is 2q and q is a positive integer greater than or equal to 2, a precoding matrix of an orthogonal space-time block code based on repetition transmission from a transmitter;
a third calculation module 702 communicating with the second receiving module 701 for obtaining, in a space-time-domain signal processing scenario, for each target code symbol, corresponding received signals at q groups of symbol moments each of which contains two consecutive symbol moments, and calculating, for two received signals obtained at each of the q groups of symbol moments, two decision variables for the same target code symbol based on a symbol-level maximum likelihood decision algorithm for the orthogonal space-time block code, and additively combining the two decision variables to obtain q initial combined decision variables corresponding to the same target code symbol; or, a fourth calculation module 703 communicating with the second receiving module 701 for obtaining, in a space-frequency-domain signal processing scenario, for each target code symbol, corresponding received signals on q groups of subcarriers each of which contains two consecutive subcarriers, and calculating, for the two received signals obtained on the q groups of subcarriers, two decision variables for the same target code symbol based on a symbol-level maximum likelihood decision algorithm for the orthogonal space-time block code, and additively combining the two decision variables to obtain q initial combined decision variables corresponding to the same target code symbol; and
a second combination module 704 communicating with the third calculation module 702 and the fourth calculation module 703 for additively combining the q initial combined decision variables corresponding to the same target code symbol to obtain a target decision variable corresponding to the target code symbol.

In an embodiment, in the space-time-domain signal processing scenario, the received signals at two consecutive symbol moments of a t^{th} symbol moment and a (t+1)^{th} symbol moment in the time domain may be represented as:

$${r}^{( t )} = {c}_{i} {h}_{1} + {c}_{i} {h}_{2} + {n}^{( t )}$$

$${r}^{( t + 1 )} = ( - {c}_{i}^{*} ) {h}_{1} + {c}_{i}^{*} {h}_{2} + {n}^{( t + 1 )}$$

wherein r^{(t)} represents a received signal in the time domain at the t^{th} symbol moment, r^{(t+1)} represents a received signal in the time domain at the (t+1)^{th} symbol moment, n^{(t)} and n^{(t+1)} represent additive white Gaussian noise sample values of the receiver at the t^{th} and (t+1)^{th} symbol moments, respectively, h₁ represents an instantaneous channel coefficient from a first transmit antenna to a single receive antenna in the space-time domain, h₂ represents an instantaneous channel coefficient from a second transmit antenna to the single receive antenna in the space-time domain, and cᵢ represents a target code symbol;

In an embodiment, in the space-frequency-domain signal processing scenario, the received signals on two consecutive subcarriers of an m^{th} subcarrier and a (m+1)^{th} subcarrier in the frequency domain may be represented as:

$${y}^{( m )} = {c}_{i} {g}_{1} + {c}_{i} {g}_{2} + {z}^{( m )}$$

$${y}^{( m + 1 )} = ( - {c}_{i}^{*} ) {g}_{1} + {c}_{i}^{*} {g}_{2} + {z}^{( m + 1 )}$$

wherein y^{(m)} represents a received signal in the frequency domain on the m^{th} subcarrier, y^{(m+1)} represents a received signal in the frequency domain on the (m+1)^{th} subcarrier, z^{(m)} and z^{(m+1)} represent additive white Gaussian noise sample values on the m^{th} and (m+1)^{th} subcarriers, respectively, g₁ represents an instantaneous channel coefficient from a first transmit antenna to a single receive antenna in the space-frequency domain, g₂ represents an instantaneous channel coefficient from a second transmit antenna to the single receive antenna in the space-frequency domain, and cᵢ represents a target code symbol.

In an embodiment, in the space-time-domain signal processing scenario, for the received signals at the two consecutive symbol moments of the t^{th} symbol moment and the (t+1)^{th} symbol moment in the time domain, the two decision variables may be calculated based on the symbol-level maximum likelihood decision algorithm for the orthogonal space-time block code according to the following formulas:

$${Δ}_{1} = {f}_{1} ( {r}^{( t )} , {r}^{( t + 1 )} , {h}_{1} , {h}_{2} ) = {( {h}_{1} )}^{*} {r}^{( t )} + {{h}_{2} ( {r}^{( t + 1 )} )}^{*} = ( {\vert {h}_{1} \vert}^{2} + {\vert {h}_{2} \vert}^{2} ) {c}_{i} + ( {( {h}_{1} )}^{*} {n}^{( t )} + {{h}_{2} ( {n}^{( t + 1 )} )}^{*} )$$

$${Δ}_{2} = {f}_{2} ( {r}^{( t )} , {r}^{( t + 1 )} , {h}_{1} , {h}_{2} ) = {( {h}_{2} )}^{*} {r}^{( t )} - {{h}_{1} ( {r}^{( t + 1 )} )}^{*} = ( {\vert {h}_{1} \vert}^{2} + {\vert {h}_{2} \vert}^{2} ) {c}_{i} + ( {( {h}_{2} )}^{*} {n}^{( t )} - {{h}_{1} ( {n}^{( t + 1 )} )}^{*} )$$

wherein Δ₁ represents a first decision variable, Δ₂ represents a second decision variable, and ƒ₁( [symbol] ) and ƒ₂( [symbol] ) represent maximum likelihood decision functions.

In an embodiment, in the space-frequency-domain signal processing scenario, for the received signals on the two consecutive subcarriers of the m^{th} subcarrier and the (m+1)^{th} subcarrier in the frequency domain, the two decision variables may be calculated based on the symbol-level maximum likelihood decision algorithm for the orthogonal space-time block code according to the following formulas:

$${Δ}_{1} = {f}_{1} ( {y}^{( m )} , {y}^{( m + 1 )} , {g}_{1} , {g}_{2} ) = {( {g}_{1} )}^{*} {y}^{( m )} + {{g}_{2} ( {y}^{( m + 1 )} )}^{*} = ( {\vert {g}_{1} \vert}^{2} + {\vert {g}_{2} \vert}^{2} ) {c}_{i} + ( {( {g}_{1} )}^{*} {z}^{( m )} + {{g}_{2} ( {z}^{( m + 1 )} )}^{*} )$$

$${Δ}_{2} = {f}_{2} ( {y}^{( m )} , {y}^{( m + 1 )} , {g}_{1} , {g}_{2} ) = {( {g}_{2} )}^{*} {y}^{( m )} - {{g}_{1} ( {y}^{( m + 1 )} )}^{*} = ( {\vert {g}_{1} \vert}^{2} + {\vert {g}_{2} \vert}^{2} ) {c}_{i} + ( {( {g}_{2} )}^{*} {z}^{( m )} - {{g}_{1} ( {z}^{( m + 1 )} )}^{*} )$$

wherein Δ₁ represents a first decision variable, Δ₂ represents a second decision variable, and ƒ₁( [symbol] ) and ƒ₂ ( [symbol] ) represent maximum likelihood decision functions.

In this embodiment, there is also provided an apparatus for performing repetition transmission using multiple transmit antennas, which is located in a transmitter. The apparatus acquires a code symbol sequence (c₁, c₂, . . . , c_{K}) after channel coding and modulation, wherein K represents a number of code symbols in the code symbol sequence; when K is an even number, converts the code symbol sequence into a code symbol sequence (s₁, s₂, . . . , s_{L}), wherein L=K, and sᵢ=cᵢ (i=1, . . . , L); when K is an odd number, additionally appends a symbol with a value of zero to the end of the code symbol sequence to obtain a code symbol sequence (s₁, s₂, . . . , s_{L}), wherein L=K+1, sᵢ=cᵢ (i=1, . . . , L−1), and s_{L}=0; converts, using an orthogonal space-time block code, every 2N symbols in the code symbol sequence (s₁, s₂, . . . , s_{L}) into a precoding matrix of the orthogonal space-time block code; and repeatedly transmits the precoding matrix to a receiver using 2N transmit antennas in matrix-wise granularity, and additionally transmits at least one bit of control information, wherein the at least one bit of control information is used to indicate to the receiver whether zero-padding has been performed at the end of a currently transmitted code symbol sequence.

In an embodiment, the repeatedly transmitting the precoding matrix to a receiver using 2N transmit antennas in matrix-wise granularity may may include:
when a value of N is 1, a number of repetition transmissions is p and p is a positive integer greater than or equal to 2, for every two code symbols sᵢ and sᵢ₊₁ in the code symbol sequence (s₁, s₂, . . . , s_{L}), representing the matrices transmitted when performing the repetition transmissions in matrix-wise granularity as:

$$[ \begin{matrix}{s}_{i} & {s}_{i + 1} \\ - {s}_{i}^{*} & {s}_{i + 1}^{*}\end{matrix} ]$$

$$…$$

$$[ \begin{matrix}{s}_{i} & {s}_{i + 1} \\ - {s}_{i + 1}^{*} & {s}_{i}^{*}\end{matrix} ]$$

wherein the first column represents transmit symbols of a first transmit antenna, and the second column represents transmit symbols of a second transmit antenna, and in a space-time-domain signal processing scenario, the first row represents transmit symbols at a t^{th} symbol moment, the second row represents transmit symbols at a (t+1)^{th} symbol moment, the second-from-last row represents transmit symbols at a (t+2p−2)^{th} symbol moment, and the last row represents transmit symbols at a (t+2p−1)^{th} symbol moment; or, in a space-frequency-domain signal processing scenario, the first row represents transmit symbols on an m^{th} subcarrier, the second row represents transmit symbols on a (m+1)^{th} subcarrier, the second-from-last row represents transmit symbols on a (m+2p−2)^{th} subcarrier, and the last row represents transmit symbols on a (m+2p−1)^{th} subcarrier; and
when a value of N is 2, a number of repetition transmissions is p, and p is a positive integer greater than or equal to 2, for every four code symbols sᵢ, sᵢ₊₁, sᵢ₊₂ and sᵢ₊₃ in the code symbol sequence (s₁, s₂, . . . , s_{L}), representing the matrices transmitted when performing the repetition transmissions in matrix-wise granularity as:

$$[ \begin{matrix}{s}_{i} & 0 & {s}_{i + 1} & 0 \\ - {s}_{i + 1}^{*} & 0 & {s}_{i}^{*} & 0 \\ 0 & {s}_{i + 2} & 0 & {s}_{i + 3} \\ 0 & - {s}_{i + 3}^{*} & 0 & {s}_{i + 2}^{*}\end{matrix} ]$$

$$…$$

$$[ \begin{matrix}{s}_{i} & 0 & {s}_{i + 1} & 0 \\ - {s}_{i + 1}^{*} & 0 & {s}_{i}^{*} & 0 \\ 0 & {s}_{i + 2} & 0 & {s}_{i + 3} \\ 0 & - {s}_{i + 3}^{*} & 0 & {s}_{i + 2}^{*}\end{matrix} ]$$

wherein the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-time-domain signal processing scenario, the first row represents transmit symbols at a t^{th} symbol moment, the second row represents transmit symbols at a (t+1)^{th} symbol moment, the third row represents transmit symbols at a (t+2)^{th} symbol moment, the fourth row represents transmit symbols at a (t+3)^{th} symbol moment, the fourth-from-last row represents transmit symbols at a (t+4p−4)^{th} symbol moment, the third-from-last row represents transmit symbols at a (t+4p−3)^{th} symbol moment, the second-from-last row represents transmit symbols at a (t+4p−2)^{th} symbol moment, and the last row represents transmit symbols at a (t+4p−1)^{th} symbol moment; or, in a space-frequency-domain signal processing scenario, the first row represents transmit symbols on an m^{th} subcarrier, the second row represents transmit symbols on a (m+1)^{th} subcarrier, the third row represents transmit symbols on a (m+2)^{th} subcarrier, the fourth row represents transmit symbols on a (m+3)^{th} subcarrier, the fourth-from-last row represents transmit symbols on a (m+4p−4)^{th} subcarrier, the third-from-last row represents transmit symbols on a (m+4p−3)^{th} subcarrier, the second-from-last row represents transmit symbols on a (m+4p−2)^{th} subcarrier, and the last row represents transmit symbols on a (m+4p−1)^{th} subcarrier.

Correspondingly, in this embodiment, there is also provided a data reception apparatus for a method of performing repetition transmission using multiple transmit antennas, which is located in a receiver. When the number of repetition transmissions is p, and p is a positive integer greater than or equal to 2, the data reception apparatus is configured for receiving a precoding matrix of an orthogonal space-time block code based on repetition transmission from a transmitter, wherein the precoding matrix of an orthogonal space-time block code is obtained by the transmitter through conversion of every 2N symbols in the code symbol sequence (s₁, s₂, . . . , s_{L}) using the orthogonal space-time block code. In a space-time-domain signal processing scenario, the receiver obtains, for every two target code symbols, corresponding received signals at p groups of symbol moments each of which contains two consecutive symbol moments; calculates, for two received signals obtained at each of the p groups of symbol moments, two initial decision variables each of which respectively corresponds to one of the two target code symbols based on a symbol-level maximum likelihood decision algorithm for the orthogonal space-time block code; and obtains, based on the corresponding p groups of received signals obtained at the p groups of symbol moments, p initial decision variables for each of the two target code symbols. Or, in a space-frequency-domain signal processing scenario, the receiver obtains, for every two target code symbols, corresponding received signals on p groups of subcarriers each of which contains two consecutive subcarriers; calculates, for two received signals obtained on each of the p groups of subcarriers, two initial decision variables each of which respectively corresponds to one of the two target code symbols based on a symbol-level maximum likelihood decision algorithm for the orthogonal space-time block code; obtains, based on the corresponding p groups of received signals obtained on the p groups of subcarriers, p initial decision variables for each of the two target code symbols; additively combines, for each of the two target code symbols, the p initial decision variables to obtain a corresponding target decision variable; and after completing decision-making and obtaining a decision result according to the target decision variable for each symbol in the code symbol sequence (s₁, s₂, . . . , s_{L}), decides whether to remove a last symbol from the decision result for the code symbol sequence (s₁, s₂, . . . , s_{L}) according to a reception result of at least one bit of control information.

The embodiments of the present application also provide a specific embodiment of an electronic device capable of implementing all the steps of the method of performing repetition transmission using multiple transmit antennas in the aforementioned embodiments. The electronic device specifically includes: a processor, a memory, a Communications Interface, and a bus, wherein the processor, memory, and communications interface complete are in communication with each other via the bus; the processor is used to call a computer program in the memory, and when the processor executes the computer program, it implements all the steps of the method of performing repetition transmission using multiple transmit antennas in the aforementioned embodiments. For example, when the processor executes the computer program, it implements the following steps:
Step 1: acquiring, by a transmitter, a code symbol sequence (c₁, c₂, . . . , c_{K}) after channel coding and modulation, wherein K represents a number of code symbols in the code symbol sequence;
Step 2: converting, using an orthogonal space-time block code, the code symbol sequence (c₁, c₂, . . . , c_{K}) into a precoding matrix of the orthogonal space-time block code based on repetition transmission;
Step 3: transmitting the precoding matrix to a receiver using 2N transmit antennas, wherein N is a positive integer greater than or equal to 1;
Step 4: receiving, by the receiver, the precoding matrix of the orthogonal space-time block code based on repetition transmission from the transmitter;
Step 5: obtaining, by the receiver, in a space-time-domain signal processing scenario, for each target code symbol, corresponding received signals at two consecutive symbol moments, and calculating, for the received signals at the two consecutive symbol moments, two decision variables for the same target code symbol based on a symbol-level maximum likelihood decision algorithm for the orthogonal space-time block code; or, obtaining, by the receiver, in a space-frequency-domain signal processing scenario, for each target code symbol, corresponding received signals on two consecutive subcarriers, and calculating, for the received signals on the two consecutive subcarriers, two decision variables for the same target code symbol based on a symbol-level maximum likelihood decision algorithm for the orthogonal space-time block code; and
Step 6: additively combining the two decision variables for the same target code symbol to obtain a target decision variable corresponding to the target code symbol.

The embodiments of the present application also provide a computer readable storage medium capable of implementing all the steps of the method of performing repetition transmission using multiple transmit antennas in the aforementioned embodiments. The computer readable storage medium stores a computer program. When the computer program is executed by a processor, all the steps of the method of performing repetition transmission using multiple transmit antennas in the aforementioned embodiments are implemented. For example, when the processor executes the computer program, it implements the following steps:
Step 1: acquiring, by a transmitter, a code symbol sequence (c₁, c₂, . . . , c_{K}) after channel coding and modulation, wherein K represents a number of code symbols in the code symbol sequence;
Step 2: converting, using an orthogonal space-time block code, the code symbol sequence (c₁, c₂, . . . , c_{K}) into a precoding matrix of the orthogonal space-time block code based on repetition transmission;
Step 3: transmitting the precoding matrix to a receiver using 2N transmit antennas, wherein N is a positive integer greater than or equal to 1;
Step 4: receiving, by the receiver, the precoding matrix of the orthogonal space-time block code based on repetition transmission from the transmitter;
Step 5: obtaining, by the receiver, in a space-time-domain signal processing scenario, for each target code symbol, corresponding received signals at two consecutive symbol moments, and calculating, for the received signals at the two consecutive symbol moments, two decision variables for the same target code symbol based on a symbol-level maximum likelihood decision algorithm for the orthogonal space-time block code; or, obtaining, by the receiver, in a space-frequency-domain signal processing scenario, for each target code symbol, corresponding received signals on two consecutive subcarriers, and calculating, for the received signals on the two consecutive subcarriers, two decision variables for the same target code symbol based on a symbol-level maximum likelihood decision algorithm for the orthogonal space-time block code; and
Step 6: additively combining the two decision variables for the same target code symbol to obtain a target decision variable corresponding to the target code symbol.

As is evident from the above descriptions, in the embodiments of the present disclosure, the transmitter acquires a code symbol sequence after channel coding and modulation, and converts, using an orthogonal space-time block code, the code symbol sequence into a precoding matrix of the orthogonal space-time block code based on repetition transmission, and then transmits the precoding matrix to a receiver using 2N transmit antennas. Accordingly, in the time domain, multiple repetition transmissions are performed for each code symbol, and in the space domain, each symbol is transmitted by each one of the multiple transmit antennas, which provides the possibility of achieving the transmit diversity gain. Through the above solutions, the technical effect of realizing a greater coverage capability improvement with lower processing complexity at the same throughput reduction cost as that of the existing repetition transmission methods is achieved.

The embodiments of the present disclosure are described in a progressive manner. For the same or similar parts among the embodiments, cross-reference can be made. Each embodiment focuses on explaining its differences from other embodiments. In particular, for embodiments of the hardware+program type, as they are substantially similar to the method embodiments, the descriptions thereof are relatively brief. For the relevant parts, please refer to the descriptions in the method embodiments.

Although the embodiments of the present disclosure provide method operational steps as described in the embodiments or flowcharts, more or fewer steps may be included based on conventional or non-inventive means. The sequence of steps listed in the embodiments is merely one of a plurality of step execution sequences and does not represent a unique execution order. When executed by an actual device or terminal product, the method may be performed sequentially or in parallel according to the order shown in the embodiments or the drawings (e.g., in parallel processor or multi-threading processing environment, or even in a distributed data processing environment). The terms “include”, “contain,” or any other variations thereof are intended to cover a non-exclusive inclusion, so that a process, method, product, or device that includes a series of elements not only includes those elements but may also include other elements that are not explicitly listed or inherent to such process, method, product, or device. Without further limitation, the existence of other identical or equivalent elements in the process, method, product, or device that includes said elements is not excluded.

For the convenience of descriptions, when the above devices are described, they are divided into various functional modules which are respectively described. Of course, when implementing the embodiments of the present disclosure, the functions of the modules may be implemented in the same one or more software and/or hardware components. Alternatively, modules implementing a same function may also be realized by a combination of multiple sub-modules or sub-units. The device embodiments described above are merely illustrative. For example, the division of units is merely a logical functional. In actual implementation, there may be other ways of division. For example, multiple units or components may be combined or integrated into another system, or some features may be omitted or not executed. Furthermore, the mutual coupling or direct coupling or communication connections shown or discussed may be indirect coupling or communication connections via some interfaces, devices, or units, which may be electrical, mechanical, or in other forms.

The present application is described with reference to the flowcharts and/or block diagrams of the methods, devices (systems), and computer program products according to the embodiments of the present disclosure. It shall be appreciated that each process and/or block in the flowcharts and/or block diagrams, as well as combinations of the processes and/or blocks in the flowcharts and/or block diagrams, can be implemented by computer program instructions. These computer program instructions may be provided to a processor of a general-purpose computer, a special-purpose computer, an embedded processing machine, or other programmable data processing devices to produce a machine, so that the instructions executed by the processor of the computer or other programmable data processing devices produce means for implementing the functions specified in one or more processes of the flowcharts and/or one or more blocks of the block diagrams.

A person skilled in the art shall appreciate that the embodiments of the present disclosure may be provided as a method, a system, or a computer program product. Accordingly, the embodiments of the present disclosure may take the form of an entirely hardware embodiment, an entirely software embodiment, or an embodiment combining both software and hardware aspects. Furthermore, the embodiments of the present disclosure may take the form of a computer program product implemented on one or more computer-usable storage media (including, but not limited to, disk storage, CD-ROM, optical storage, etc.) having a computer-usable program code embodied therein.

The embodiments of the present disclosure are all described in a progressive manner. For the same or similar parts among the embodiments, cross-reference can be made. Each embodiment focuses on explaining its differences from other embodiments. In particular, for system embodiments, since they are substantially similar to the method embodiments, the descriptions for them are relatively brief. For the relevant parts, please refer to the descriptions of the method embodiments. In the descriptions in the present disclosure, the descriptions with reference to the terms such as “an embodiment”, “some embodiments”, “example”, “specific example” or “some examples” mean that the specific features, structures, materials, or characteristics described in connection with the embodiments or examples are included in at least one embodiment or example of the embodiments of the present disclosure. In the present disclosure, the illustrative expressions of the above terms do not necessarily refer to the same embodiment or example. Moreover, the specific features, structures, materials, or characteristics that are described may be combined in a suitable manner in any one or more embodiments or examples. Furthermore, without contradicting each other, a person skilled in the art may combine and integrate different embodiments or examples described in the present disclosure and the features of different embodiments or examples.

The foregoing descriptions are merely specific embodiments of this application and are not intended to limit this application. For a person skilled in the art, the present application may have various modifications and variations. Any modifications, equivalent replacements, improvements, etc., made within the spirit and principles of the present application shall fall within the scope of the claims of the present application.

1. A method of performing repetition transmission using multiple transmit antennas, comprising steps of:
acquiring a code symbol sequence (c₁, c₂, . . . , c_{K}) after channel coding and modulation, wherein K represents a number of code symbols in the code symbol sequence, and K is a positive integer;
converting, using an orthogonal space-time block code, the code symbol sequence (c₁, c₂, . . . , c_{K}) into a precoding matrix of the orthogonal space-time block code based on repetition transmission; and
transmitting the precoding matrix using 2N transmit antennas, wherein N is a positive integer greater than or equal to 1.

2. The method according to claim 1, wherein the step of converting, using an orthogonal space-time block code, of the code symbol sequence (c₁, c₂, . . . , c_{K}) into a precoding matrix of the orthogonal space-time block code based on repetition transmission comprises:
when a value of N is 1 and a number of repetition transmissions is 2, for each code symbol cᵢ in the code symbol sequence, representing a converted precoding matrix of the orthogonal space-time block code based on repetition transmission as:
$$[ \begin{matrix}{c}_{i} & {c}_{i} \\ - {c}_{i}^{*} & {c}_{i}^{*}\end{matrix} ]$$
wherein the first column represents transmit symbols of a first transmit antenna, and the second column represents transmit symbols of a second transmit antenna, and in a space-time-domain signal processing scenario, the first row represents transmit symbols at a t^{th} symbol moment, and the second row represents transmit symbols at a (t+1)^{th} symbol moment.

3. The method according to claim 1, wherein the step of converting, using an orthogonal space-time block code, of the code symbol sequence (c₁, c₂, . . . , c_{K}) into a precoding matrix of the orthogonal space-time block code based on repetition transmission comprises:
when a value of N is 1 and a number of repetition transmissions is 2, for each code symbol cᵢ in the code symbol sequence, representing a converted precoding matrix of the orthogonal space-time block code based on repetition transmission as:
$$[ \begin{matrix}{c}_{i} & {c}_{i} \\ - {c}_{i}^{*} & {c}_{i}^{*}\end{matrix} ]$$
wherein the first column represents transmit symbols of a first transmit antenna, and the second column represents transmit symbols of a second transmit antenna, and in a space-frequency-domain signal processing scenario, the first row represents transmit symbols on an m^{th} subcarrier, and the second row represents transmit symbols on an (m+1)^{th} subcarrier.

4. The method according to claim 1, wherein the step of converting, using an orthogonal space-time block code, of the code symbol sequence (c₁, c₂, . . . , c_{K}) into a precoding matrix of the orthogonal space-time block code based on repetition transmission comprises:
when a value of N is 1 and a number of repetition transmissions is 2q, for each code symbol cᵢ in the code symbol sequence, representing converted precoding matrices of the orthogonal space-time block code based on repetition transmission as:
$$[ \begin{matrix}{c}_{i} & {c}_{i} \\ - {c}_{i}^{*} & {c}_{i}^{*}\end{matrix} ]$$
$$…$$
$$[ \begin{matrix}{c}_{i} & {c}_{i} \\ - {c}_{i}^{*} & {c}_{i}^{*}\end{matrix} ]$$
wherein q is a positive integer greater than or equal to 2, the first column represents transmit symbols of a first transmit antenna, and the second column represents transmit symbols of a second transmit antenna, and in a space-time-domain signal processing scenario, the first row represents transmit symbols at a t^{th} symbol moment, the second row represents transmit symbols at a (t+1)^{th} symbol moment, the second-from-last row represents transmit symbols at a (t+2q−2)^{th} symbol moment, and the last row represents transmit symbols at a (t+2q−1)^{th} symbol moment.

5. The method according to claim 1, wherein the step of converting, using an orthogonal space-time block code, of the code symbol sequence (c₁, c₂, . . . , c_{K}) into a precoding matrix of the orthogonal space-time block code based on repetition transmission comprises:
when a value of N is 1 and a number of repetition transmissions is 2q, for each code symbol cᵢ in the code symbol sequence, representing converted precoding matrices of the orthogonal space-time block code based on repetition transmission as:
$$[ \begin{matrix}{c}_{i} & {c}_{i} \\ - {c}_{i}^{*} & {c}_{i}^{*}\end{matrix} ]$$
$$…$$
$$[ \begin{matrix}{c}_{i} & {c}_{i} \\ - {c}_{i}^{*} & {c}_{i}^{*}\end{matrix} ]$$
wherein q is a positive integer greater than or equal to 2, the first column represents transmit symbols of a first transmit antenna, and the second column represents transmit symbols of a second transmit antenna, and in a space-frequency-domain signal processing scenario, the first row represents transmit symbols on an m^{th} subcarrier, the second row represents transmit symbols on a (m+1)^{th} subcarrier, the second-from-last row represents transmit symbols on a (m+2q−2)^{th} subcarrier, and the last row represents transmit symbols on a (m+2q−1)^{th} subcarrier.

6. The method according to claim 1, wherein the step of converting, using an orthogonal space-time block code, of the code symbol sequence (c₁, c₂, . . . , c_{K}) into a precoding matrix of the orthogonal space-time block code based on repetition transmission comprises:
when a value of N is 2 and a number of repetition transmissions is 2, for every two code symbols cᵢ and cᵢ₊₁ in the code symbol sequence, representing a converted precoding matrix of the orthogonal space-time block code based on repetition transmission as:
$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$
wherein the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-time-domain signal processing scenario, the first row represents transmit symbols at a t^{th} symbol moment, the second row represents transmit symbols at a (t+1)^{th} symbol moment, the third row represents transmit symbols at a (t+2)^{th} symbol moment, and the fourth row represents transmit symbols at a (t+3)^{th} symbol moment.

7. The method according to claim 1, wherein the step of converting, using an orthogonal space-time block code, of the code symbol sequence (c₁, c₂, . . . , c_{K}) into a precoding matrix of the orthogonal space-time block code based on repetition transmission comprises:
when a value of N is 2 and a number of repetition transmissions is 2, for every two code symbols cᵢ and cᵢ₊₁ in the code symbol sequence, representing a converted precoding matrix of the orthogonal space-time block code based on repetition transmission as:
$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$
wherein the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-frequency-domain signal processing scenario, the first row represents transmit symbols on an m^{th} subcarrier, the second row represents transmit symbols on a (m+1)^{th} subcarrier, the third row represents transmit symbols on a (m+2)^{th} subcarrier, and the fourth row represents transmit symbols on a (m+3)^{th} subcarrier.

8. The method according to claim 1, wherein the step of converting, using an orthogonal space-time block code, of the code symbol sequence (c₁, c₂, . . . , c_{K}) into a precoding matrix of the orthogonal space-time block code based on repetition transmission comprises:
when a value of N is 2 and a number of repetition transmissions is 2q, for every two code symbols cᵢ and cᵢ₊₁ in the code symbol sequence, representing converted precoding matrices of the orthogonal space-time block code based on repetition transmission as:
$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$
$$…$$
$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$
wherein q is a positive integer greater than or equal to 2, the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-time-domain signal processing scenario, the first row represents transmit symbols at a t^{th} symbol moment, the second row represents transmit symbols at a (t+1)^{th} symbol moment, the third row represents transmit symbols at a (t+2)^{th} symbol moment, the fourth row represents transmit symbols at a (t+3)^{th} symbol moment, the fourth-from-last row represents transmit symbols at a (t+4q−4)^{th} symbol moment, the third-from-last row represents transmit symbols at a (t+4q−3)^{th} symbol moment, the second-from-last row represents transmit symbols at a (t+4q−2)^{th} symbol moment, and the last row represents transmit symbols at a (t+4q−1)^{th} symbol moment.

9. The method according to claim 1, wherein the step of converting, using an orthogonal space-time block code, of the code symbol sequence (c₁, c₂, . . . , c_{K}) into a precoding matrix of the orthogonal space-time block code based on repetition transmission comprises:
when a value of N is 2 and a number of repetition transmissions is 2q, for every two code symbols cᵢ and cᵢ+1 in the code symbol sequence, representing converted precoding matrices of the orthogonal space-time block code based on repetition transmission as:
$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$
$$…$$
$$[ \begin{matrix}{c}_{i} & 0 & {c}_{i} & 0 \\ - {c}_{i}^{*} & 0 & {c}_{i}^{*} & 0 \\ 0 & {c}_{i + 1} & 0 & {c}_{i + 1} \\ 0 & - {c}_{i + 1}^{*} & 0 & {c}_{i + 1}^{*}\end{matrix} ]$$
wherein q is a positive integer greater than or equal to 2, the first column represents transmit symbols of a first transmit antenna, the second column represents transmit symbols of a second transmit antenna, the third column represents transmit symbols of a third transmit antenna, and the fourth column represents transmit symbols of a fourth transmit antenna, and in a space-frequency-domain signal processing scenario, the first row represents transmit symbols on an m^{th} subcarrier, the second row represents transmit symbols on a (m+1)^{th} subcarrier, the third row represents transmit symbols on a (m+2)^{th} subcarrier, the fourth row represents transmit symbols on a (m+3)^{th} subcarrier, the fourth-from-last row represents transmit symbols on a (m+4q−4)^{th} subcarrier, the third-from-last row represents transmit symbols on a (m+4q−3)^{th} subcarrier, the second-from-last row represents transmit symbols on a (m+4q−2)^{th} subcarrier, and the last row represents transmit symbols on a (m+4q−1)^{th} subcarrier.

10. A data reception method, wherein when a number of repetition transmissions is 2, the method comprises:
receiving a precoding matrix of an orthogonal space-time block code based on repetition transmission;
obtaining, in a space-time-domain signal processing scenario, for each target code symbol, corresponding received signals at two consecutive symbol moments, and calculating, for the received signals at the two consecutive symbol moments, two decision variables for the same target code symbol based on a symbol-level maximum likelihood decision algorithm for the orthogonal space-time block code; or, obtaining, in a space-frequency-domain signal processing scenario, for each target code symbol, corresponding received signals on two consecutive subcarriers, and calculating, for the received signals on the two consecutive subcarriers, two decision variables for the same target code symbol based on the symbol-level maximum likelihood decision algorithm for the orthogonal space-time block code; and
additively combining the two decision variables for the same target code symbol to obtain a target decision variable corresponding to the target code symbol.

11. The method according to claim 10, wherein in the space-time-domain signal processing scenario, the received signals at two consecutive symbol moments of a t^{th} symbol moment and a (t+1)^{th} symbol moment in a time domain are represented as:
$${r}^{( t )} = {c}_{i} {h}_{1} + {c}_{i} {h}_{2} + {n}^{( t )}$$
$${r}^{( t + 1 )} = ( - {c}_{i}^{*} ) {h}_{1} + {c}_{i}^{*} {h}_{2} + {n}^{( t + 1 )}$$
wherein r^{(t)} represents a received signal in the time domain at the t^{th} symbol moment, r^{(t+1)} represents a received signal in the time domain at the (t+1)^{th} symbol moment, n^{(t)} and n^{(t+1)} represent additive white Gaussian noise sample values at the t^{th} and (t+1)^{th} symbol moments, respectively, h₁ represents an instantaneous channel coefficient from a first transmit antenna to a single receive antenna in a space-time domain, h₂ represents an instantaneous channel coefficient from a second transmit antenna to the single receive antenna in the space-time domain, and cᵢ represents a target code symbol.

12. The method according to claim 10, wherein in the space-frequency-domain signal processing scenario, the received signals on two consecutive subcarriers of a k^{th} subcarrier and a (k+1)^{th} subcarrier in a frequency domain are represented as:
$${y}^{( m )} = {c}_{i} {g}_{1} + {c}_{i} {g}_{2} + {z}^{( m )}$$
$${y}^{( m + 1 )} = ( - {c}_{i}^{*} ) {g}_{1} + {c}_{i}^{*} {g}_{2} + {z}^{( m + 1 )}$$
wherein y^{(m)} represents a received signal in the frequency domain on the m^{th} subcarrier, y^{(m+1)} represents a received signal in the frequency domain on the (m+1)^{th} subcarrier, z^{(m)} and z^{(m+1)} represent additive white Gaussian noise sample values on the m^{th} and (m+1)^{th} subcarriers, respectively, g₁ represents an instantaneous channel coefficient from the first transmit antenna to the single receive antenna in a space-frequency domain, g₂ represents an instantaneous channel coefficient from the second transmit antenna to the single receive antenna in the space-frequency domain, and cᵢ represents the target code symbol.

13. The method according to claim 10, wherein in the space-time-domain signal processing scenario, for the received signals at the two consecutive symbol moments of the t^{th} symbol moment and the (t+1)^{th} symbol moment in a time domain, the two decision variables are calculated based on the symbol-level maximum likelihood decision algorithm for the orthogonal space-time block code according to the following formulas:
$${Δ}_{1} = {f}_{1} ( {r}^{( t )} , {r}^{( t + 1 )} , {h}_{1} , {h}_{2} ) = {( {h}_{1} )}^{*} {r}^{( t )} + {{h}_{2} ( {r}^{( t + 1 )} )}^{*} = ( {\vert {h}_{1} \vert}^{2} + {\vert {h}_{2} \vert}^{2} ) {c}_{i} + ( {( {h}_{1} )}^{*} {n}^{( t )} + {{h}_{2} ( {n}^{( t + 1 )} )}^{*} )$$
$${Δ}_{2} = {f}_{2} ( {r}^{( t )} , {r}^{( t + 1 )} , {h}_{1} , {h}_{2} ) = {( {h}_{2} )}^{*} {r}^{( t )} - {{h}_{1} ( {r}^{( t + 1 )} )}^{*} = ( {\vert {h}_{1} \vert}^{2} + {\vert {h}_{2} \vert}^{2} ) {c}_{i} + ( {( {h}_{2} )}^{*} {n}^{( t )} - {{h}_{1} ( {n}^{( t + 1 )} )}^{*} )$$
wherein Δ₁ represents a first decision variable, Δ₂ represents a second decision variable, and ƒ₁ ( [symbol] ) and ƒ₂ ( [symbol] ) represent maximum likelihood decision functions.

14. The method according to claim 10, wherein in the space-frequency-domain signal processing scenario, for the received signals on the two consecutive subcarriers of the m^{th} subcarrier and the (m+1)^{th} subcarrier in a frequency domain, the two decision variables are calculated based on the symbol-level maximum likelihood decision algorithm for the orthogonal space-time block code according to the following formulas:
$${Δ}_{1} = {f}_{1} ( {y}^{( m )} , {y}^{( m + 1 )} , {g}_{1} , {g}_{2} ) = {( {g}_{1} )}^{*} {y}^{( m )} + {{g}_{2} ( {y}^{( m + 1 )} )}^{*} = ( {\vert {g}_{1} \vert}^{2} + {\vert {g}_{2} \vert}^{2} ) {c}_{i} + ( {( {g}_{1} )}^{*} {z}^{( m )} + {{g}_{2} ( {z}^{( m + 1 )} )}^{*} )$$
$${Δ}_{2} = {f}_{2} ( {y}^{( m )} , {y}^{( m + 1 )} , {g}_{1} , {g}_{2} ) = {( {g}_{2} )}^{*} {y}^{( m )} - {{g}_{1} ( {y}^{( m + 1 )} )}^{*} = ( {\vert {g}_{1} \vert}^{2} + {\vert {g}_{2} \vert}^{2} ) {c}_{i} + ( {( {g}_{2} )}^{*} {z}^{( m )} - {{g}_{1} ( {z}^{( m + 1 )} )}^{*} )$$
wherein Δ₁ represents the first decision variable, Δ₂ represents the second decision variable, and ƒ₁( [symbol] ) and ƒ₂ ( [symbol] ) represent the maximum likelihood decision functions.

15. A data reception method, wherein when a number of repetition transmissions is 2q and q is a positive integer greater than or equal to 2, the method comprises:
receiving a precoding matrix of an orthogonal space-time block code based on repetition transmission;
obtaining, in a space-time-domain signal processing scenario, for each target code symbol, corresponding received signals at q groups of symbol moments each of which contains two consecutive symbol moments, and calculating, for two received signals obtained at each of the q groups of symbol moments, two decision variables for the same target code symbol based on a symbol-level maximum likelihood decision algorithm for the orthogonal space-time block code, and additively combining the two decision variables to obtain one of q initial combined decision variables corresponding to the same target code symbol; or, obtaining, in a space-frequency-domain signal processing scenario, for each target code symbol, corresponding received signals on q groups of subcarriers each of which contains two consecutive subcarriers, and calculating, for two received signals obtained on each of the q groups of subcarriers, two decision variables for the same target code symbol based on the symbol-level maximum likelihood decision algorithm for the orthogonal space-time block code, and additively combining the two decision variables to obtain one of q initial combined decision variables corresponding to the same target code symbol; and
additively combining the q initial combined decision variables corresponding to the same target code symbol to obtain a target decision variable corresponding to the target code symbol.

16. The data reception method according to claim 15, wherein in the space-time-domain signal processing scenario, the received signals at two consecutive symbol moments of a t^{th} symbol moment and a (t+1)^{th} symbol moment in a time domain are represented as:
$${r}^{( t )} = {c}_{i} {h}_{1} + {c}_{i} {h}_{2} + {n}^{( t )}$$
$${r}^{( t + 1 )} = ( - {c}_{i}^{*} ) {h}_{1} + {c}_{i}^{*} {h}_{2} + {n}^{( t + 1 )}$$
wherein r^{(t)} represents a received signal in the time domain at the t^{th} symbol moment, r^{(t+1)} represents a received signal in the time domain at the (t+1)^{th} symbol moment, n^{(t)} and n^{(t+1)} represent additive white Gaussian noise sample values at the t^{th} and (t+1)^{th} symbol moments, respectively, h₁ represents an instantaneous channel coefficient from a first transmit antenna to a single receive antenna in a space-time domain, h₂ represents an instantaneous channel coefficient from a second transmit antenna to the single receive antenna in the space-time domain, and cᵢ represents a target code symbol.

17. The data reception method according to claim 15, wherein in the space-frequency-domain signal processing scenario, the received signals on two consecutive subcarriers of a k^{th} subcarrier and a (k+1)^{th} subcarrier in a frequency domain are represented as:
$${y}^{( m )} = {c}_{i} {g}_{1} + {c}_{i} {g}_{2} + {z}^{( m )}$$
$${y}^{( m + 1 )} = ( - {c}_{i}^{*} ) {g}_{1} + {c}_{i}^{*} {g}_{2} + {z}^{( m + 1 )}$$
wherein y^{(m)} represents a received signal in the frequency domain on the m^{th} subcarrier, y^{(m+1)} represents a received signal in the frequency domain on the (m+1)^{th} subcarrier, z^{(m)} and z^{(m+1)} represent additive white Gaussian noise sample values on the m^{th} and (m+1)^{th} subcarriers, respectively, g₁ represents an instantaneous channel coefficient from the first transmit antenna to the single receive antenna in a space-frequency domain, g₂ represents an instantaneous channel coefficient from the second transmit antenna to the single receive antenna in the space-frequency domain, and cᵢ represents the target code symbol.

18. The data reception method according to claim 15, wherein in the space-time-domain signal processing scenario, for the received signals at the two consecutive symbol moments of the t^{th} symbol moment and the (t+1)^{th} symbol moment in a time domain, the two decision variables are calculated based on the symbol-level maximum likelihood decision algorithm for the orthogonal space-time block code according to the following formulas:
$${Δ}_{1} = {f}_{1} ( {r}^{( t )} , {r}^{( t + 1 )} , {h}_{1} , {h}_{2} ) = {( {h}_{1} )}^{*} {r}^{( t )} + {{h}_{2} ( {r}^{( t + 1 )} )}^{*} = ( {\vert {h}_{1} \vert}^{2} + {\vert {h}_{2} \vert}^{2} ) {c}_{i} + ( {( {h}_{1} )}^{*} {n}^{( t )} + {{h}_{2} ( {n}^{( t + 1 )} )}^{*} )$$
$${Δ}_{2} = {f}_{2} ( {r}^{( t )} , {r}^{( t + 1 )} , {h}_{1} , {h}_{2} ) = {( {h}_{2} )}^{*} {r}^{( t )} - {{h}_{1} ( {r}^{( t + 1 )} )}^{*} = ( {\vert {h}_{1} \vert}^{2} + {\vert {h}_{2} \vert}^{2} ) {c}_{i} + ( {( {h}_{2} )}^{*} {n}^{( t )} - {{h}_{1} ( {n}^{( t + 1 )} )}^{*} )$$
wherein Δ₁ represents a first decision variable, Δ₂ represents a second decision variable, and ƒ₁ ( [symbol] ) and ƒ₂ ( [symbol] ) represent maximum likelihood decision functions.

19. The data reception method according to claim 15, wherein in the space-frequency-domain signal processing scenario, for the received signals on the two consecutive subcarriers of the m^{th} subcarrier and the (m+1)^{th} subcarrier in a frequency domain, the two decision variables are calculated based on the symbol-level maximum likelihood decision algorithm for the orthogonal space-time block code according to the following formulas:
$${Δ}_{1} = {f}_{1} ( {y}^{( m )} , {y}^{( m + 1 )} , {g}_{1} , {g}_{2} ) = {( {g}_{1} )}^{*} {y}^{( m )} + {{g}_{2} ( {y}^{( m + 1 )} )}^{*} = ( {\vert {g}_{1} \vert}^{2} + {\vert {g}_{2} \vert}^{2} ) {c}_{i} + ( {( {g}_{1} )}^{*} {z}^{( m )} + {{g}_{2} ( {z}^{( m + 1 )} )}^{*} )$$
$${Δ}_{2} = {f}_{2} ( {y}^{( m )} , {y}^{( m + 1 )} , {g}_{1} , {g}_{2} ) = {( {g}_{2} )}^{*} {y}^{( m )} - {{g}_{1} ( {y}^{( m + 1 )} )}^{*} = ( {\vert {g}_{1} \vert}^{2} + {\vert {g}_{2} \vert}^{2} ) {c}_{i} + ( {( {g}_{2} )}^{*} {z}^{( m )} - {{g}_{1} ( {z}^{( m + 1 )} )}^{*} )$$
wherein Δ₁ represents the first decision variable, Δ₂ represents the second decision variable, and ƒ₁( [symbol] ) and ƒ₂ ( [symbol] ) represent the maximum likelihood decision functions.
